(19) United States
(12) Patent Application Publication
(10) Pub. No.: US 2026/0126750 A1
(43) Pub. Date: May 7, 2026

(54) IMAGE FORMING SYSTEM AND INFORMATION PROCESSING APPARATUS

(71) Applicant: CANON KABUSHIKI KAISHA, Tokyo (JP)

(72) Inventor: MASATO SUZUKI, Shizuoka (JP)

(21) Appl. No.: 19/377,517

(22) Filed: Nov. 3, 2025

(30) Foreign Application Priority Data
Nov. 5, 2024 (JP) 2024-193958

(51) Int. Cl. G03G 15/00

(52) U.S. Cl. CPC G03G 15/703; G03G 15/5029; G03G 15/6561; G03G 2215/004; G03G 2215/00405; G03G 2215/00548

(57) ABSTRACT

An image forming apparatus includes a paper feed unit that includes a paper feed contact portion which comes into contact with the recording material stored in a storage unit, and that feeds the recording material in contact with the paper feed contact portion. The image forming apparatus further includes a separation unit provided downstream of the paper feed unit in a conveyance direction of the recording material, and that includes a separation contact portion which comes into contact with the fed recording material. In a case where information based on a result of detecting the recording material being conveyed indicates that a plurality of recording materials are simultaneously positioned in a notification section, An information processing apparatus gives notification such that a display apparatus displays information regarding that the plurality of recording materials are present in the notification section.

### BACKGROUND

### Field of the Technology

The present disclosure relates to an image forming system and an information processing apparatus.

### Description of the Related Art

The image forming apparatus described in Japanese Patent Laid-Open No. 2011-152983 detects a no-feed jam in which a recording material does not reach a conveyance roller from a storage unit of the recording material.

### SUMMARY

The present disclosure provides an image forming apparatus (image forming system) that detects a state in which a recording material is not normally conveyed.

According to one aspect of the present disclosure, there is provided an image forming system an image forming system comprising: an image forming apparatus; an information processing apparatus that can communicate with the image forming apparatus; and a display apparatus that can display information, wherein the image forming apparatus includes a storage unit that store a recording material, a paper feed unit that includes a paper feed contact portion which comes into contact with the recording material stored in the storage unit, and that feeds the recording material which is in contact with the paper feed contact portion, a separation unit that is provided downstream of the paper feed unit in a conveyance direction in which the paper feed unit conveys the recording material, and that includes a separation contact portion which comes into contact with the recording material fed by the paper feed unit, the separation unit separating the recording material into one to convey the recording material, and a detection unit that detects the recording material being conveyed, in a case where information based on a detection result of the detection unit indicates that a plurality of recording materials are simultaneously positioned in a notification section, the information processing apparatus gives notification such that the display apparatus displays information regarding that the plurality of recording materials are present in the notification section, and the notification section is a section which is downstream of a midpoint of a line segment connecting the paper feed contact portion and the separation contact portion, and which is upstream of the separation contact portion, in the conveyance direction.

According to another aspect of the present disclosure, there is provided an information processing apparatus an information processing apparatus that can communicate with an image forming apparatus, the image forming apparatus including a storage unit that stores a recording material, a paper feed unit that includes a paper feed contact portion which comes into contact with the recording material stored in the storage unit, and that feeds the recording material which is in contact with the paper feed contact portion, a separation unit that is provided downstream of the paper feed unit in a conveyance direction in which the paper feed unit conveys the recording material, and that includes a separation contact portion which comes into contact with the recording material fed by the paper feed unit, the separation unit separating the recording material into one to convey the recording material, and a detection unit that detects the recording material being conveyed, the information processing apparatus comprising: a control unit that gives notification by causing a display apparatus to display information regarding that a plurality of recording materials are present in a notification section in a case where information based on a detection result of the detection unit received from the image forming apparatus indicates that the plurality of recording materials are simultaneously positioned in the notification section, wherein the notification section is a section which is downstream of a midpoint of a line segment connecting the paper feed contact portion and the separation contact portion, and which is upstream of the separation contact portion, in the conveyance direction.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a cross-sectional view illustrating a hardware configuration example of an image forming apparatus.

FIG. 2 is a cross-sectional view illustrating a configuration example related to paper feed of a sheet in the image forming apparatus.

FIG. 3 is a block diagram illustrating a control configuration example of the image forming apparatus.

FIG. 4 illustrates an example of a state in which a sheet is set in a paper feed cassette.

FIGS. 5A and 5B illustrate paper feed examples of a topmost sheet S1 by a pick roller (pickup roller).

FIG. 6 illustrates an example of a state in which a sheet bundle has entered to the vicinity of a separation position.

FIG. 7 illustrates an example of a paper feed start position of the topmost sheet S1.

FIG. 8 illustrates an example of a sensor reach time corresponding to each paper feed start position.

FIGS. 9A to 9C illustrate examples of the paper feed start position of the topmost sheet S1.

FIG. 10 is a scatter diagram illustrating a distribution example of measurement results of a sensor reach time Ts.

FIG. 11 is a flowchart showing a procedure of processing for determining that a plurality of sheets are present in the vicinity of the separation position.

FIG. 12 illustrates a configuration example of an image forming system including a server apparatus.

FIG. 13 is a cross-sectional view illustrating a configuration example related to paper feed of a sheet in the image forming apparatus (second embodiment).

FIG. 14 illustrates an example of a state of an output signal of a sheet sensor (second embodiment).

FIGS. 15A and 15B are a cross-sectional view illustrating a configuration example related to paper feed of a sheet in the image forming apparatus, and a schematic view illustrating a configuration example of a rotation detection unit (third embodiment).

FIGS. 16A and 16B illustrate operation examples of an encoder at the time of reach of a sheet (fourth embodiment).

FIG. 17 illustrates an example of a state indicated by an output signal of a photointerrupter (fourth embodiment).

FIG. 18 is a cross-sectional view illustrating a configuration example related to paper feed of a sheet in the image forming apparatus (fifth embodiment).

FIGS. 19A and 19B illustrate operation examples of the rotation detection unit at the time of reach of a sheet to the separation position (fifth embodiment).

FIG. 20 is a cross-sectional view illustrating a configuration example related to paper feed of a sheet in the image forming apparatus (sixth embodiment).

FIG. 21 is a top view illustrating a configuration example related to paper feed of a sheet in the image forming apparatus (sixth embodiment).

FIG. 22 illustrates an example of a temporal change in torque of a drive motor (sixth embodiment).

FIG. 23 is a cross-sectional view illustrating a configuration example related to paper feed of a sheet in the image forming apparatus (modification).

FIG. 24 illustrates an example of a screen to be displayed on a display unit 301 of a maintenance computer 300.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

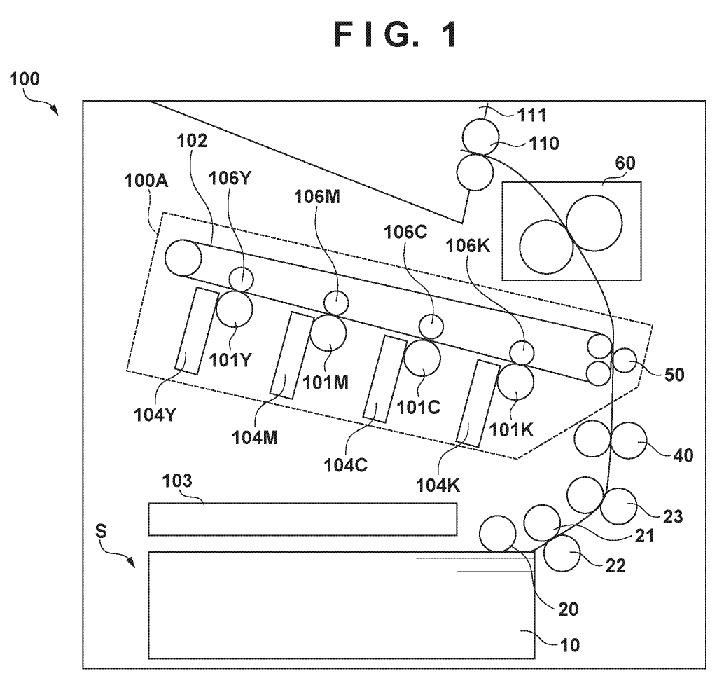

FIG. 1 is a cross-sectional view illustrating a schematic configuration example of an image forming apparatus according to the first embodiment. Hereinafter, the present embodiment will be described with an image forming apparatus 100 configured as an electrophotographic color laser printer as an example.

The image forming apparatus 100 includes an image forming unit 100A that forms toner images of four colors of yellow (Y), magenta (M), cyan (C), and black (K). The image forming unit 100A includes four photosensitive drums (photosensitive members) 101Y, 101M, 101C, and 101K, and an intermediate transfer belt 102. Note that Y, M, C, and K at the end of the reference numerals indicate that the colors of the developer (toner) targeted by corresponding members are yellow, magenta, cyan, and black, respectively. The image forming unit 100A further includes primary transfer rollers 106Y, 106M, 106C, and 106K that superimpose, on the intermediate transfer belt 102, toner images formed on the photosensitive drums 101Y, 101M, 101C, and 101K to transfer (primary transfer) the toner images. By being applied with a transfer voltage from a transfer power source (not illustrated), the primary transfer rollers 106Y, 106M, 106C, and 106K generate a potential difference between the photosensitive drums 101Y, 101M, 101C, and 101K and the intermediate transfer belt 102. This potential difference causes the toner image to be primarily transferred from the photosensitive drums 101Y, 101M, 101C, and 101K to the intermediate transfer belt 102. The image forming unit 100A further includes a secondary transfer roller 50 that transfers (secondarily transfers), onto a sheet S, the toner image transferred onto the intermediate transfer belt 102.

When the image forming operation by the image forming unit 100A is started, the photosensitive drums 101Y, 101M, 101C, and 101K uniformly charged are irradiated with light corresponding to an image signal by a laser scanner 103. By this, electrostatic latent images are formed on the photosensitive drums 101Y, 101M, 101C, and 101K. The image forming unit 100A forms toner images (visible images) by developing the electrostatic latent images on the corresponding photosensitive drums 101Y, 101M, 101C, and 101K by the toners stored in developing cartridges 104Y, 104M, 104C, and 104K. The toner images of the respective colors formed on the photosensitive drums 101Y, 101M, 101C, and 101K are superimposed and transferred onto the intermediate transfer belt 102 as described above. By this, multicolor toner images are formed on the intermediate transfer belt 102. Thereafter, the toner image formed on the intermediate transfer belt 102 is conveyed to a secondary transfer portion by the intermediate transfer belt 102. The secondary transfer portion corresponds to a nip portion formed between the intermediate transfer belt 102 and the secondary transfer roller 50.

In accordance with the timing of such an image forming operation, the sheet S is fed from a paper feed cassette 10 to a conveyance path, and is conveyed to the image forming unit 100A (secondary transfer portion) through the conveyance path. Specifically, a pick roller (pickup roller) 20, a feed roller 21, and a separation roller 22 feed and convey the sheets S one by one from the paper feed cassette 10. The sheets are conveyed to the secondary transfer portion by a conveyance roller pair 23 and a registration roller pair 40. Note that the registration roller pair 40 performs skew correction of the sheet S. Note that the paper feed cassette 10 is an example of a storage unit that stores a recording material (sheet) used for image formation.

The sheet S is conveyed to the secondary transfer portion in accordance with the timing at which the toner image on the intermediate transfer belt 102 is conveyed to the secondary transfer portion. With a secondary transfer voltage is applied to the secondary transfer roller 50, the toner image is transferred from the intermediate transfer belt 102 to the sheet S. The sheet S to which the toner image has been transferred is then conveyed to a fixing unit 60, and heated and pressurized at the fixing unit 60, whereby the toner image is fixed on the sheet S. After such fixing processing is performed, the sheet S is discharged to a discharge portion 111 in the upper part of the apparatus by a discharge roller 110.

### Configuration Related to Paper Feed of Sheet

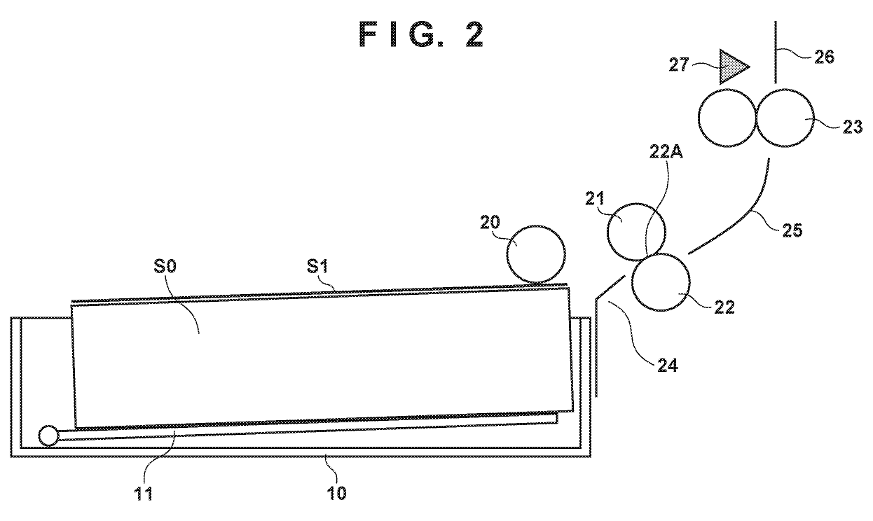

FIG. 2 is a cross-sectional view illustrating a configuration example related to paper feed of a sheet in the image forming apparatus 100. The paper feed cassette 10 stores the sheet S (sheet bundle S0). The paper feed cassette 10 includes an intermediate plate (lift-up plate) 11 axially supported in the paper feed cassette 10 and configured to perform a rotation operation. The sheet S1 is the topmost sheet to be fed next from the paper feed cassette 10 to the conveyance path in the sheet bundle S0.

The pick roller 20 is arranged so as to press the sheet bundle S0 lifted up by the intermediate plate 11 downward in the drawing by a spring (not illustrated) as described later. The feed roller 21 and the separation roller 22 constitute a separation unit (sheet separation unit) that separates sheets one by one from the sheet bundle S0 (separates the topmost sheet S1) to send the sheets to the conveyance path. The feed roller 21 and the separation roller 22 are pressed by a spring (not illustrated) from the separation roller 22 side to the feed roller 21 side, thereby forming a contact state. The contact portion between the feed roller 21 and the separation roller 22 corresponds to a separation position

22A (separation contact portion) where sheet separation (separation of the topmost sheet S1 from other sheets) is performed. Each of the pick roller 20, the feed roller 21, and the separation roller 22 includes a rubber roller. The conveyance roller pair 23 includes a rubber roller and a roller, and is pressed by a spring (not illustrated) from the roller side to the rubber roller side, thereby forming a contact state.

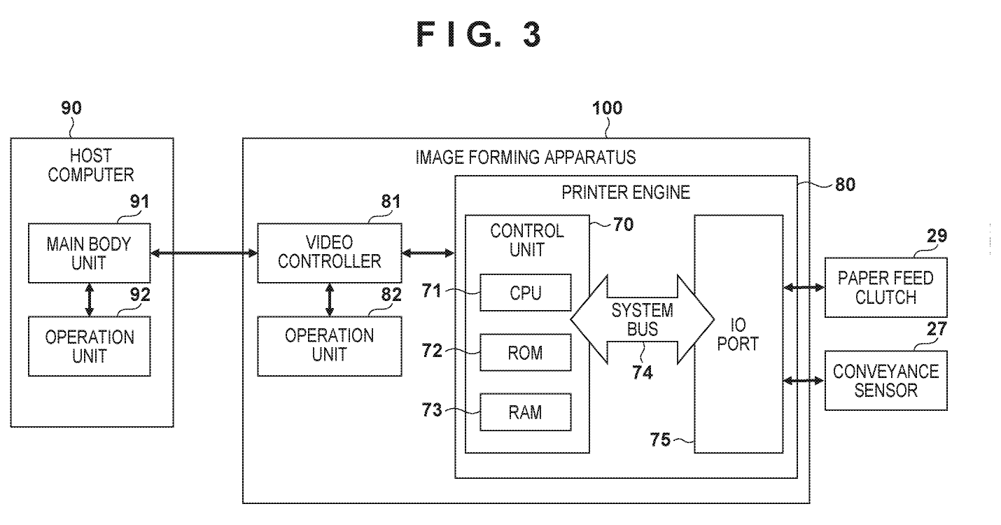

The conveyance path of the sheet S1 is provided with a pre-separation guide 24, a post-separation guide 25, and a conveyance guide 26 that guide the sheet S1 to be conveyed by the pick roller 20, the feed roller 21, and the conveyance roller pair 23. Driving force is transmitted from a motor (not illustrated) used as an identical driving source to the pick roller 20, the feed roller 21, and the conveyance roller pair 23. Transmission of the driving force from the motor to the pick roller 20 and the feed roller 21 is controlled by on/off of a paper feed clutch 29 (FIG. 3) described later.

In the present embodiment, a conveyance sensor 27 is further arranged downstream of the conveyance roller pair 23 in the conveyance path of the sheet S1. The conveyance sensor 27 includes a photointerrupter and a flag (not illustrated), and is used to detect (the leading edge of) the sheet S1. When the leading edge of the sheet S1 comes into contact with the flag and it is detected that an optical axis of the photointerrupter is shielded from light, it is determined that the leading edge of the sheet S1 reaches the conveyance sensor 27.

Next, the feed and conveyance operation of a sheet from the paper feed cassette 10 will be described. When the sheet bundle S0 is stored in the paper feed cassette 10, the lowermost surface of the sheet bundle S0 is placed on the intermediate plate 11 of the paper feed cassette 10. When the paper feed cassette 10 is mounted to the image forming apparatus 100, the intermediate plate 11 is driven by a drive motor (not illustrated) and rotates about a rotation fulcrum, whereby the sheet bundle S0 is lifted up by the intermediate plate 11. By this, the pick roller 20 comes into contact with the sheet bundle S0. When the pick roller 20 is brought into a state of pressing the topmost sheet S1 with a predetermined pressure, lift-up by the intermediate plate 11 is stopped, and the position of the sheet S1 is maintained.

Thereafter, when the paper feed clutch 29 (FIG. 3) is brought into an on state by an instruction from a control unit 70 (FIG. 3), the pick roller 20 starts the rotation operation. By this, paper feed of the topmost sheet S1 of the sheet bundle S0 in the paper feed cassette 10 is started, and the topmost sheet S1 is conveyed to a contact portion (separation position 22A) formed between the feed roller 21 and the separation roller 22 while being guided by the pre-separation guide 24.

The separation roller 22 incorporates a torque limiter (not illustrated). The rotational torque of the torque limiter is set in advance such that the separation roller 22 rotates when sheets are conveyed one by one, and the separation roller 22 does not rotate when a plurality of sheets are conveyed. In this manner, the sheet S1 separated one by one by the separation roller 22 to be conveyed is conveyed to the conveyance roller pair 23 while being guided by the post-separation guide 25. The sheet S1 conveyed by the conveyance roller pair 23 is conveyed to the registration roller pair 40 while being guided by the conveyance guide 26.

In the present embodiment, the pick roller 20 is an example of a paper feed unit, that includes a paper feed contact portion that comes into contact with the recording material (sheet) stored in the storage unit (paper feed cassette 10), and feeds, to the conveyance path, the recording material in contact with the paper feed contact portion. The feed roller 21 and the separation roller 22 are examples of a separation unit (sheet separation units) provided downstream of the paper feed unit in the conveyance direction in which the paper feed unit (pick roller 20) conveys the recording material, the separation unit including a separation contact portion that comes into contact with the recording material (sheet) fed by the paper feed unit, the separation unit separating the recording material into one to convey the recording material. The conveyance sensor 27 is an example of a detection unit that detects the recording material (sheet) being conveyed. In the present embodiment, the detection unit (conveyance sensor 27) is arranged downstream of the sheet separation unit (feed roller 21 and separation roller 22) in the sheet conveyance direction. In the present description, detection of the recording material by the detection unit includes not only direct detection of the recording material by the detection unit but also indirect detection, which is to detect movement of a specific member accompanying movement of the recording material.

### Control Configuration of Image Forming Apparatus

FIG. 3 is a block diagram illustrating a control configuration example of the image forming apparatus 100. As illustrated in the drawing, the image forming apparatus 100 can communicate with an external apparatus such as a host computer 90 via a network. The host computer 90 includes a main body unit 91 and an operation unit 92. The main body unit 91 is configured to instruct the image forming apparatus 100 to execute printing (image forming operation) via the network. The operation unit 92 includes a display device (e.g., liquid crystal display) that outputs information to the user and an input device (e.g., touch panel sensor, keyboard, or pointing device) that receives an instruction from the user.

The image forming apparatus 100 includes a printer engine 80, a video controller 81, and an operation unit 82. The operation unit 82 includes a display device (e.g., liquid crystal display) that outputs information to the user and an input device (e.g., touch panel sensor or operation key) that receives an instruction from the user. The video controller 81 transmits, to the printer engine 80, the print data and the print instruction received from the host computer 90.

The printer engine 80 includes a control unit (engine control unit) 70, a system bus 74, and an input/output (IO) port 75. The control unit 70 includes a CPU 71, a ROM 72, and a RAM 73, and controls the entire operation of the image forming apparatus 100. The CPU 71 deploys, into the RAM 73, the program and various data stored in the ROM 72, and executes the program using the RAM 73 as a work area. The control unit 70 (CPU 71) can access the IO port 75 via the system bus 74, which is bidirectionally accessible. The paper feed clutch 29 and the conveyance sensor 27 are connected to the IO port 75. The CPU 71 controls these devices via the IO port 75. Devices other than the paper feed clutch 29 and the conveyance sensor 27 may be further connected to the IO port 75. By switching the paper feed clutch 29 from an off state to the on state, the control unit 70 (CPU 71) starts the rotation operation of the pick roller 20 and starts the paper feed operation of the topmost sheet S1.

### Paper Feed Operation and Measurement of Sensor Reach Time

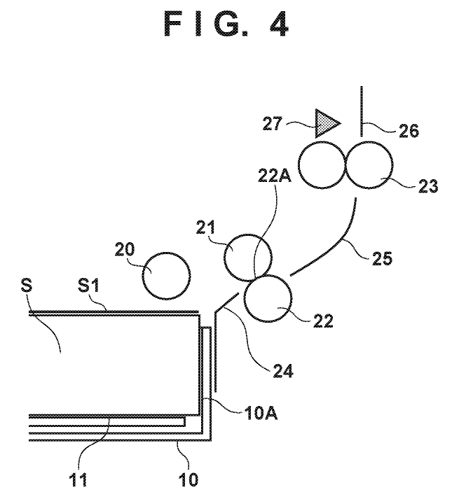

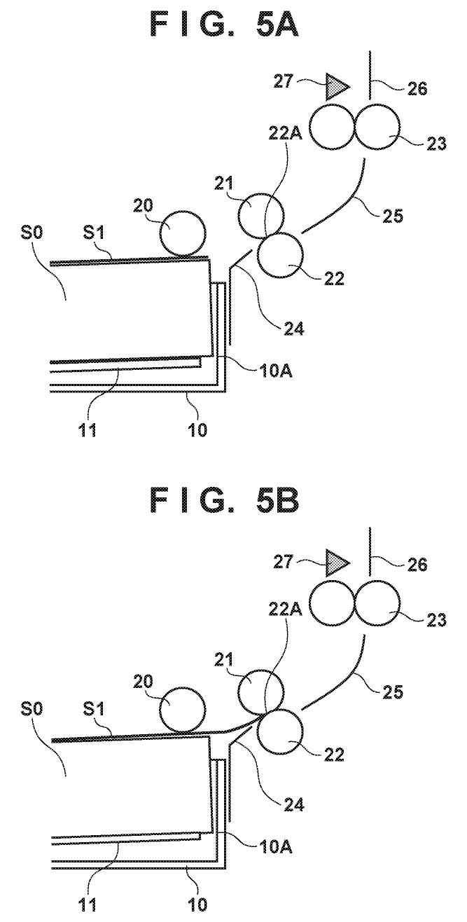

With reference to FIGS. 4, 5A and 5B, the sheet paper feed operation and measurement of the sensor reach time Ts, which is a time from the paper feed start timing of the sheet to the detection timing of the sheet by the conveyance sensor 27, will be described.

FIG. 4 illustrates an example of a state in which the sheet bundle S0 is set in the paper feed cassette 10, and illustrates a state immediately before lift-up of the sheet bundle S0 by the intermediate plate 11 is started. FIGS. 5A and 5B illustrate paper feed examples of the topmost sheet S1 by the pick roller 20. FIG. 5A illustrates a state in which lift-up of the sheet bundle S0 is completed and before paper feed of the topmost sheet S1 is started. Note that in the following description, the position of the leading edge of the topmost sheet S1 at the time of completing the lift-up of the sheet bundle S0 in the paper feed cassette 10 illustrated in FIG. 5A is referred to as a "cassette position" (cassette position 10B in FIG. 7). FIG. 5B illustrates a state in which the topmost sheet S1 is fed from the paper feed cassette 10 and the leading edge of the topmost sheet S1 reaches the separation position 22A.

In the image forming apparatus 100 of the present embodiment, as in FIG. 4, it is recommended to set the sheet bundle S0 such that the sheet bundle S0 abuts against a leading edge portion 10A of the paper feed cassette 10. When the paper feed cassette 10 is mounted to the image forming apparatus 100 in a state in which the sheet bundle S0 is set in this manner, lift-up of the sheet bundle S0 by the intermediate plate 11 is started by an instruction of the control unit 70. The lift-up of the sheet bundle S0 is completed in the state of FIG. 5A.

The operation of the image forming apparatus 100 from the start of feed (conveyance) of the topmost sheet S1 in the state illustrated in FIG. 5A until the leading edge of the sheet reaches the position of the conveyance sensor 27 will be further described. Note that in the present embodiment, the rotation speeds of the pick roller 20, the feed roller 21, and the conveyance roller pair 23 are all controlled to be constant until the paper feed operation by the pick roller 20 is started and the leading edge of the sheet S1 reaches the position of the conveyance sensor 27.

First, the CPU 71 switches the paper feed clutch 29 from the off state to the on state by transmitting a control signal for paper feed operation start to the paper feed clutch 29 through the system bus 74 and the IO port 75. By this, the rotation operation of the pick roller 20 is started, and the feed (conveyance) of the topmost sheet S1 is started. The CPU 71 stores a transmission timing of the control signal for paper feed start in the RAM 73 as a paper feed start timing T1.

Thereafter, the topmost sheet S1 conveyed by the paper feed roller 20 is conveyed to the conveyance sensor 27 by the feed roller 21 and the conveyance roller pair 23. When the leading edge of the topmost sheet S1 is detected by the conveyance sensor 27, the output signal of the conveyance sensor 27 is switched from the off state to the on state. The CPU 71 monitors an output signal of the conveyance sensor 27 via the IO port 75 and the system bus 74. Based on the output signal of the conveyance sensor 27, the CPU 71 stores the timing at which the leading edge of the topmost sheet S1 is detected by the conveyance sensor 27 into the RAM 73 as a sheet detection timing T2. The CPU 71 measures and stores, into the RAM 73, the time from the paper feed start timing T1 to the sheet detection timing T2 as the sensor reach time Ts. In this manner, in the present embodiment, the CPU 71 functions as an example of a measurement unit that measures the time (sensor reach time Ts) from the paper feed start timing of the recording material to the detection timing of the recording material by the detection unit.

In the image forming apparatus 100, when feed of several sheets from the paper feed cassette 10 is continued, the leading edge of the topmost sheet S1 may move from the cassette position illustrated in FIG. 5A to the separation position 22A illustrated in FIG. 5B. In this case, feed (conveyance) of the topmost sheet S1 is started from the separation position 22A. In the present embodiment, the pick roller 20 and the feed roller 21 are driven by the same drive system. Therefore, when the paper feed clutch 29 is brought into the on state and the pick roller 20 starts the rotation operation, the feed roller 21 also starts the rotation operation. That is, the feed roller 21 also starts rotation at the paper feed start timing T1, and the topmost sheet S1 is conveyed to the conveyance sensor 27 by the feed roller 21 and the conveyance roller pair 23. Similarly to the case where paper feed of the topmost sheet S1 is started from the cassette position illustrated in FIG. 5A, the CPU 71 measures the sensor reach time Ts for the topmost sheet S1 fed from the separation position 22A and conveyed to the position of the conveyance sensor 27.

Here, a measurement value of the sensor reach time Ts measured in a case where paper feed of the topmost sheet S1 is started from the cassette position illustrated in FIG. 5A is defined as Ta. A measurement value of the sensor reach time Ts measured in a case where paper feed of the topmost sheet S1 is started from the separation position 22A illustrated in FIG. 5B is defined as Tb. In this case, the sensor reach times Ta and Tb have a relationship of Ta > Tb. This is because the separation position 22A illustrated in FIG. 5B is present more downstream in the sheet conveyance direction than the cassette position illustrated in FIG. 5A is. That is, it is because the conveyance distance of the sheet from the separation position 22A illustrated in FIG. 5B to the position of the conveyance sensor 27 is shorter than the conveyance distance of the sheet from the cassette position illustrated in FIG. 5A to the position of the conveyance sensor 27.

### Factor of Conveyance Delay or Paper Jam in Sheet Separation unit

In a case where a plurality of sheets have collectively entered a region in the vicinity of the separation position 22A, a delay can occur in conveyance of the topmost sheet S1 or a paper jam can finally occur. Such a phenomenon can occur due to the user pulling out the paper feed cassette 10 and replenishing (adding) a plurality of sheets to the paper feed cassette 10 in a state in which the sheet bundle S0 remains in the paper feed cassette 10, for example.

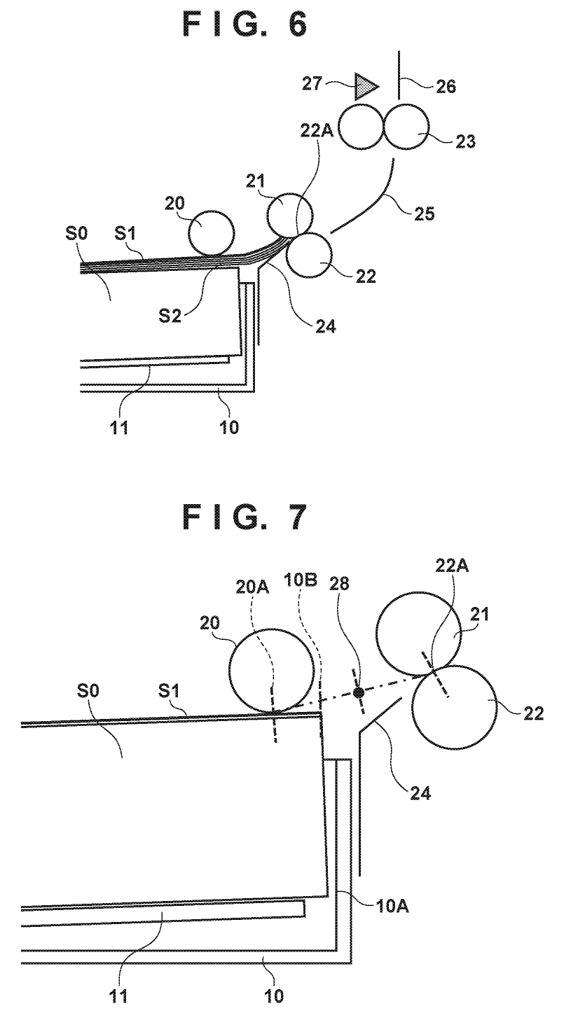

Here, FIG. 6 illustrates an example of a state in which (the leading edge of) a sheet bundle S2 including a plurality of sheets has entered (the region of) the vicinity of the separation position 22A. In the present embodiment, the sheet bundle S2 is a sheet bundle replenished (added) to the paper feed cassette 10 by the user pulling out the paper feed cassette 10 in a state in which the sheet bundle S0 remains in the paper feed cassette 10.

As illustrated in FIG. 6, when the sheet bundle S2 is added onto the sheet bundle S0 in a state in which the sheet bundle S0 remains in the paper feed cassette 10, the friction coefficient between the topmost sheet of the sheet bundle S0 and the lowermost sheet of the sheet bundle S2 may decrease. In this case, when the paper feed operation is started by the instruction of the control unit 70 and the pick roller 20 starts rotation, a phenomenon in which not only the topmost sheet S1 (of the sheet bundle including the sheet bundles S0 and S2) but also the added sheet bundle S2 have collectively entered the vicinity of the separation position 22A can occur. For example, in a case where 10 or more sheets are added as the sheet bundle S2, when those sheets enter the vicinity of the separation position 22A, those sheets are sandwiched by the feed roller 21 and the pre-separation guide 24, whereby the conveyance resistance increases. As a result, although the pick roller 20 and the feed roller 21 rotate in an attempt to convey the sheet, it is difficult to convey the topmost sheet S1 due to such an increase in conveyance resistance. This can lead to a delay in conveyance of the sheet S1 or an occurrence of a paper jam.

### Determination Processing for Plurality of Sheets

In the image forming apparatus 100 of the present embodiment, the control unit 70 (CPU 71) performs processing of determining (detecting) a state in which a plurality of sheets have entered (a region of) the vicinity of the separation position 22A at the start of the sheet paper feed operation. This can determine a conveyance delay of the sheet or a paper jam due to a plurality of sheets entering the vicinity of the separation position 22A.

FIG. 7 illustrates a pick roller position 20A, a cassette position 10B, a separation position 22A, and a midpoint position 28 as examples of the paper feed start position of the topmost sheet S1. The paper feed start position corresponds to the leading edge position of the sheet at the timing (paper feed start timing) when the paper feed operation of the sheet (topmost sheet S1) is started by the instruction of the control unit 70. In FIG. 7, the pick roller position 20A is a position where the pick roller 20 comes into contact with the topmost sheet S1, and corresponds to the paper feed contact portion. The cassette position 10B is a position of the leading edge of the topmost sheet S1 when lift-up of the sheet bundle S0 in the paper feed cassette 10 is completed. The separation position 22A corresponds to the separation contact portion where the feed roller 21 and the separation roller 22 come into contact with each other, and is a position where separation of the topmost sheet S1 from the other sheets is performed. The midpoint position 28 is a position of the midpoint of a line segment connecting the pick roller position 20A (paper feed contact portion) and the separation position 22A (separation contact portion).

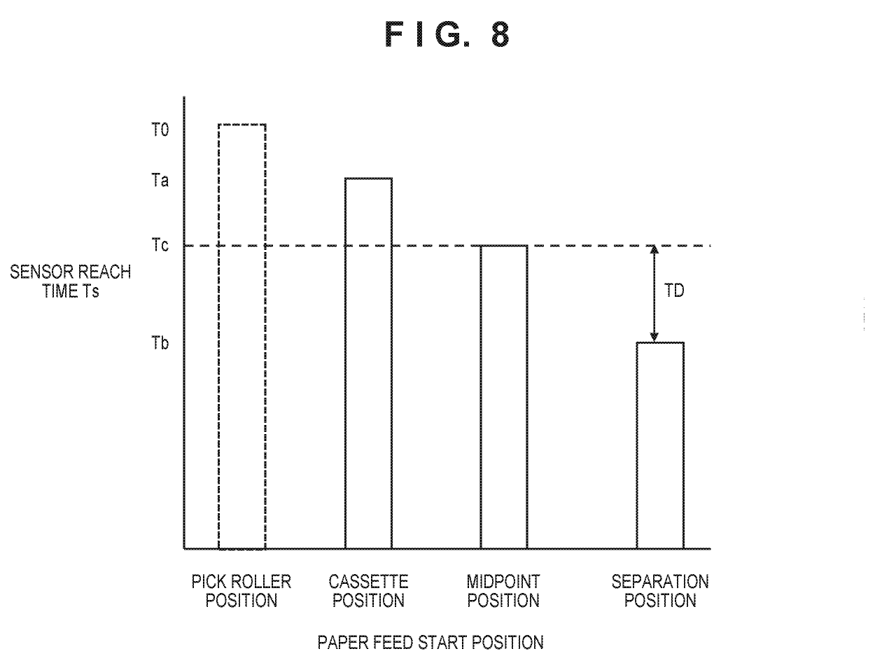

FIG. 8 illustrates an example of the sensor reach time Ts in a case where feed of the topmost sheet S1 is started in a state in which the leading edge of the topmost sheet S1 is positioned at each paper feed start position illustrated in FIG. 7. The sensor reach time Ts is a time from a timing (paper feed start timing T1) at which the paper feed operation of the sheet (topmost sheet S1) is started by the instruction of the control unit 70 to a timing (sheet detection timing T2) at which the sheet is detected by the conveyance sensor 27.

FIG. 8 illustrates sensor reach times T0, Ta, Tc, and Tb corresponding to the pick roller position 20A, the cassette position 10B, the midpoint position 28, and the separation position 22A, respectively, as measurement results of the sensor reach time Ts. The sensor reach time T0 is a sensor reach time measured when paper feed of the topmost sheet S1 is started in a state in which the leading edge of the sheet is positioned at the pick roller position 20A. The sensor reach time Ta is a sensor reach time measured when paper feed of the topmost sheet S1 is started in a state in which the leading edge of the sheet is positioned at the cassette position 10B. The sensor reach time Tc is a sensor reach time measured when paper feed of the topmost sheet S1 is started in a state in which the leading edge of the sheet is positioned at the midpoint position 28. The sensor reach time Tb is a sensor reach time measured when paper feed of the topmost sheet S1 is started in a state in which the leading edge of the sheet is positioned at the separation position 22A.

Along the sheet conveyance direction, the pick roller position 20A, the cassette position 10B, the midpoint position 28, and the separation position 22A are closer to the position of the conveyance sensor 27 in this order. That is, the conveyance distance from each paper feed start position to the position of the conveyance sensor 27 becomes short. Therefore, as illustrated in FIG. 8, the sensor reach times T0, Ta, Tc, and Tb respectively corresponding to the pick roller position 20A, the cassette position 10B, the midpoint position 28, and the separation position 22A are shorter in this order (i.e., T0 > Ta > Tc > Tb is true).

In the present embodiment, a predetermined section that is a section upstream of the sheet separation unit (separation position 22A) in the sheet conveyance direction, the section having the separation position 22A as an end point in the sheet conveyance direction, is set in advance as a detection section TD (notification section) for detecting that a plurality of sheets are present in (have entered) (the region in) the vicinity of the separation position 22A at the start timing of the paper feed operation. The control unit 70 measures a time (sensor reach time Ts) from the start timing T1 of the paper feed operation of the topmost sheet S1 to the timing T2 at which the sheet S1 is detected by the conveyance sensor 27. The control unit 70 measures the sensor reach time Ts every time the topmost sheet S1 is fed by the paper feed operation, and determines whether or not the plurality of sheets are present in the detection section TD (the region in the vicinity of the separation position 22A) based on the measurement result.

In the present embodiment, as an example, a section from the midpoint position 28 to the separation position 22A in the sheet conveyance direction is set as the detection section TD. The detection section TD is defined as, for example, a time section based on the sensor reach time. Specifically, a time section shorter than the sensor reach time Tc corresponding to the midpoint position 28 is defined as (a time section corresponding to) the detection section TD. This can detect that the paper feed start position of the topmost sheet S1 fed by the paper feed operation is within the detection section TD in a case where the sensor reach time Ts measured for the topmost sheet S1 is shorter than Tc (Ts < Tc). In the present embodiment, in a case where the measured sensor reach time Ts of the plurality of sheets is shorter than Tc (Ts < Tc), the control unit 70 determines that the plurality of sheets are present within (have entered) the detection section TD.

In the present embodiment, the detection section TD is defined based on the sensor reach time Ts (i.e., time information) in this manner, but the detection section TD may be defined based on distance information. For example, in a case where the drive system of the pick roller 20 and the feed roller 21 is provided with an encoder that detects the number of rotations and the encoder can acquire distance information (conveyance distance of the sheet), the detection section TD may be defined using the distance information. In the present embodiment, the section from the midpoint position 28 to the separation position 22A is defined as the detection section TD, but a section different from this section (e.g., a section from the midpoint position 28 to the position of the conveyance sensor 27) may be defined as the detection section TD.

### Determination Processing Based on Sensor Reach Time

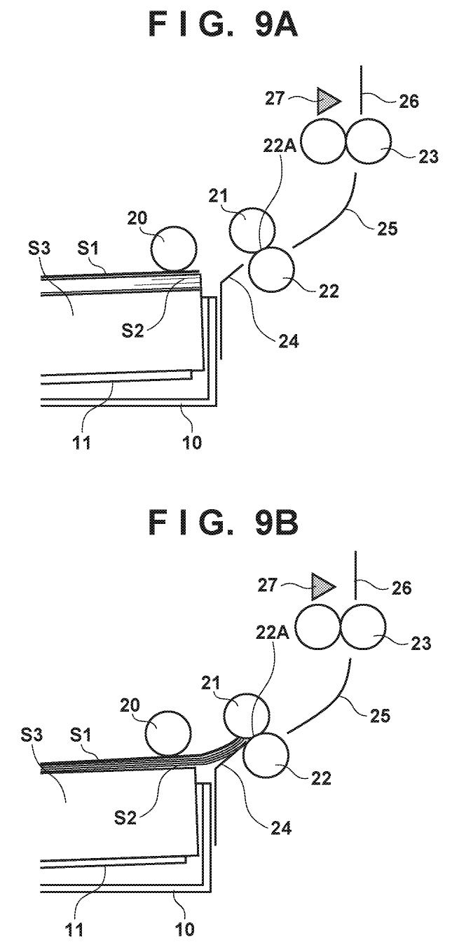

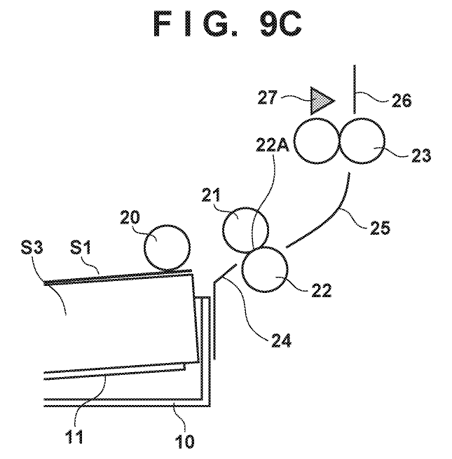

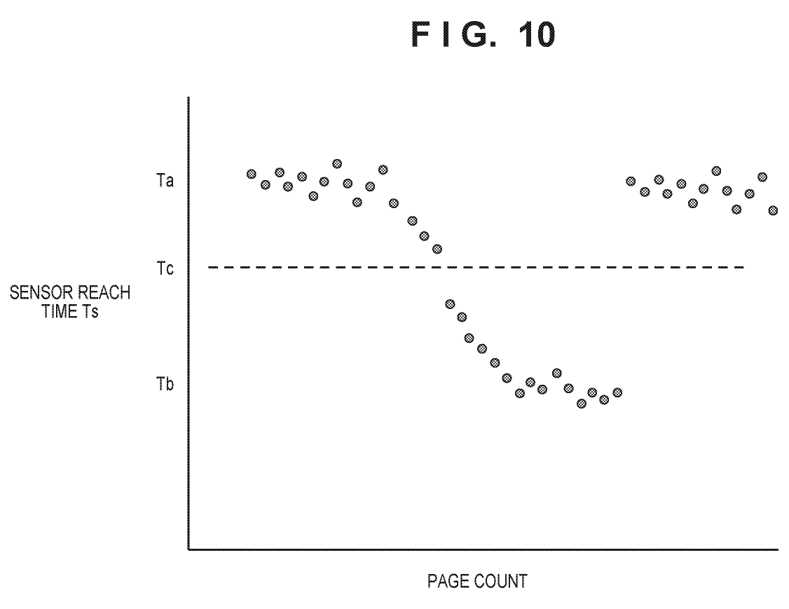

Determination processing based on the sensor reach time Ts measured as described above will be described more specifically with reference to FIGS. 9A to 9C and 10.

FIGS. 9A to 9C illustrate examples of the paper feed start position of the topmost sheet S1 in a sheet bundle set in the paper feed cassette 10. FIG. 9A illustrates a state in which the leading edge of the added sheet bundle S2 is present at the cassette position 10B (FIG. 7). FIG. 9B illustrates a state in which the leading edge of the added sheet bundle S2 is present at the separation position 22A. FIG. 9C illustrates a state in which the leading edge of a sheet bundle S3 remaining in the paper feed cassette 10 is at the cassette position 10B (FIG. 7) after the sheet bundle S2 is fed. The sheet bundle S3 is a remaining sheet bundle remaining in the paper feed cassette 10 before the sheet bundle S2 is replenished (added) into the paper feed cassette 10. FIG. 10 is a scatter diagram illustrating a distribution example of the measurement results of the sensor reach time Ts in each state of FIGS. 9A to 9C, where the horizontal axis indicates the page count and the vertical axis indicates the sensor reach time Ts.

In the example of FIG. 9A, a plurality of (e.g., 30) sheets are added onto the remaining sheet bundle S3 as the sheet bundle S2. In a case where the paper feed operation is performed in a state in which the leading edge of the sheet bundle S2 is present at the cassette position 10B in this manner, the measurement values of the sensor reach time Ts are distributed in the vicinity of the sensor reach time Ta corresponding to the cassette position 10B as in FIG. 10.

Thereafter, upon completion of conveyance of a certain number of (e.g., 15) sheets of the added sheet bundle S2, the remaining sheets of the added sheet bundle S2 are collectively conveyed to the vicinity of the separation position 22A as in FIG. 9B due to a decrease in the friction coefficient described above between the added sheets and the original remaining sheets. By this, paper feed of the topmost sheet S1 is started from the position more downstream in the conveyance direction than the midpoint position 28 (FIG. 7). As a result, as illustrated in FIG. 10, the measurement values of the sensor reach time Ts become shorter than the sensor reach time Tc corresponding to the midpoint position 28, and are distributed in the vicinity of the sensor reach time Tb corresponding to the separation position 22A.

After the paper feed of the added sheet bundle S2 ends, the remaining sheet bundle S3 is fed. Since the leading edge of the remaining sheet bundle S3 is present at the cassette position 10B (FIG. 7), the paper feed start position of the topmost sheet S1 returns from the (vicinity of) separation position 22A to the cassette position 10B. As a result, as illustrated in FIG. 10, the measurement values of the sensor reach time Ts of the topmost sheet S1 are distributed again in the vicinity of the sensor reach time Ta corresponding to the cassette position 10B.

Based on the measurement result of the sensor reach time Ts of the topmost sheet S1, the control unit 70 (CPU 71) performs processing of determining that a plurality of sheets are present in the vicinity of (have entered) the separation position 22A as in FIG. 9B. For this determination processing, the control unit 70 includes a sheet counter for counting sheets in the detection section TD (sheets whose paper feed start position is in the detection section TD). The control unit 70 measures the sensor reach time Ts every time the topmost sheet S1 is fed, and when determining that the measured sensor reach time Ts is within the detection section TD, performs processing of incrementing the count value of the sheet counter by 1. On the other hand, when determining that the measured sensor reach time Ts is out of the detection section TD, the control unit 70 performs processing of decrementing the count value of the sheet counter by 1 (in a case where the count value is 0, it is kept at 0). This count value is held in the RAM 73.

For example, when the count value held in the RAM 73 becomes a predetermined threshold or more, the control unit 70 determines that a plurality of sheets are present in the vicinity of (have entered) the separation position 22A. The control unit 70 notifies of the determination result as necessary (e.g., notifies the user by displaying it on the operation unit 82).

### Processing Procedure

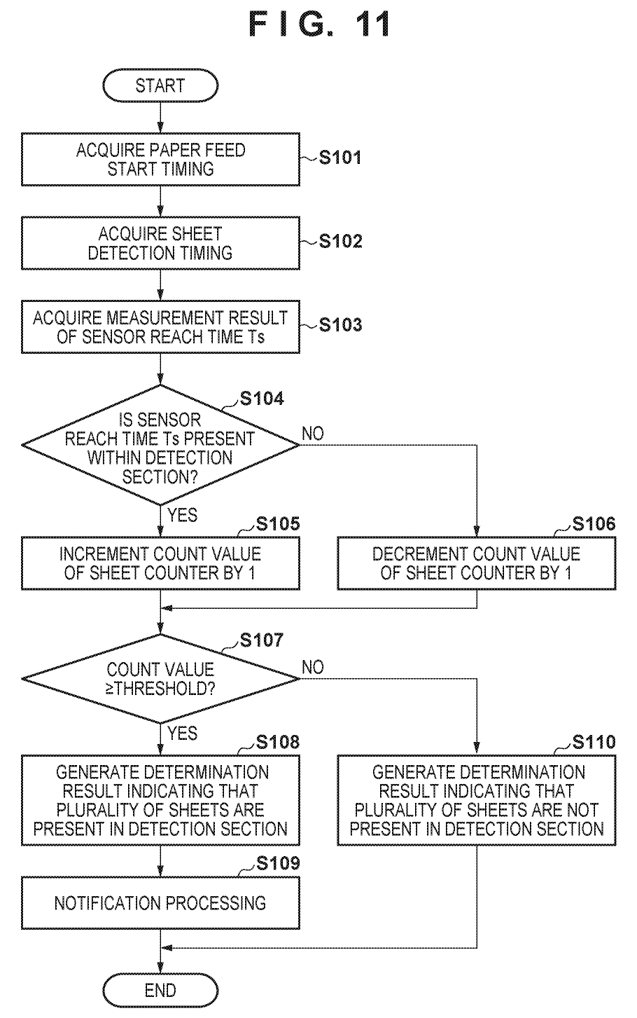

FIG. 11 is a flowchart showing an example of the processing procedure to be executed by the control unit 70 (CPU 71) in the image forming apparatus 100. The present procedure is a procedure of processing for determining that a plurality of sheets are present in the vicinity of (have entered) the separation position 22A. The control unit 70 (CPU 71) executes processing according to the present procedure every time sheets set in the paper feed cassette 10 are fed one by one.

In S101, upon transmitting a control signal for paper feed start to the paper feed clutch 29, the CPU 71 (control unit 70) acquires a transmission timing of the control signal as the start timing (paper feed start timing) T1 of the paper feed operation. Thereafter, in S102, the CPU 71 acquires the timing (sheet detection timing) T2 at which the fed sheet (topmost sheet S1) is detected by the conveyance sensor 27 based on the output signal of the conveyance sensor 27. In S103, the CPU 71 acquires (calculates) the sensor reach time Ts based on the paper feed start timing T1 and the sheet detection timing T2, thereby acquiring the measurement result of the sensor reach time Ts.

In S104, the CPU 71 determines whether or not the measured sensor reach time Ts is present within the detection section TD. This determination corresponds to determining whether or not the paper feed start position of the fed sheet is within the detection section TD. In a case where the sensor reach time Ts is present within the detection section TD (Ts ≤ Tc in the present embodiment) (i.e., in a case where the paper feed start position of the fed sheet is within the detection section TD), the CPU 71 increments the count value of the sheet counter held in the RAM 73 by 1 in S105, and advances the processing to S107. On the other hand, in a case where the sensor reach time Ts is not within the detection section TD (Ts > Tc in the present embodiment) (i.e., in a case where the paper feed start position of the fed sheet is out of the detection section TD), the CPU 71 decrements the count value of the sheet counter held in the RAM 73 by 1 in S106, and advances the processing to S107.

In S107, the CPU 71 determines whether or not the count value of the sheet counter is a predetermined threshold or more (the number of threshold sheets). The threshold is set to 10, for example. In a case where the count value is the threshold or more, the CPU 71 generates a determination result indicating that the plurality of sheets are at the (vicinity of) separation position 22A (the plurality of sheets are present in the detection section TD) in S108, and advances the processing to S109. In S109, the CPU 71 performs notification processing for notifying of the determination result in S108 (e.g., display of a determination result in the operation unit 82), and ends the processing.

In a case where the count value is less than the predetermined threshold, the CPU 71 advances the processing from S107 to S110, generates a determination result indicating that the plurality of sheets are not present at the (vicinity of) separation position 22A (the plurality of sheets are not present in the detection section TD), and ends the processing.

As in FIG. 9B, in a case where the plurality of sheets added to the paper feed cassette 10 are present in the vicinity of (have entered) the separation position 22A, the count value of the sheet counter in S105 increases every time the sheet is fed. When the number of sheets (count value) determined to be present within the detection section TD finally becomes the threshold number of sheets (10 sheets in the present embodiment) or more, the CPU 71 performs processing of determining that a plurality of sheets are present in the vicinity of the separation position 22A.

Note that the count value of the sheet counter described above may be reset for each section of a predetermined number of sheets. For example, a section of 15 sheets may be set as the section of a predetermined number of sheets, and the count value may be reset at the stage where the number of fed sheets exceeds 15. Furthermore, the number of times a plurality of sheets are determined to be present at the (vicinity of) separation position 22A for each section of a predetermined number of sheets may be held, for example, for each user. This enables a user with a large number of times, for example, to be determined as a user who tends to have a plurality of sheets enter the separation position 22A at the paper feed start in a case of setting sheets (sheet bundle) into the paper feed cassette 10. The control unit 70 (CPU 71) may perform processing of notifying of the determination result. Alternatively, the count value of the sheet counter may be reset every time the opening and closing operation of the paper feed cassette 10 is performed without providing the section of the number of sheets described above.

### Example of Notification Processing

In a case of determining that a plurality of sheets have entered the sheet separation unit (vicinity of the separation position 22A), the control unit 70 may notify of the determination result using the operation unit 82. For example, the control unit 70 may display, on the operation unit 82, a message indicating that a plurality of sheets have entered the vicinity of the sheet separation unit.

The control unit 70 may give the above-described notification in response to determining that a plurality of sheets have entered the sheet separation unit. Alternatively, the control unit 70 may give such a notification at the stage of performing determination, a plurality of times, that a plurality of sheets have entered the sheet separation unit (i.e., may notify of a tendency for a plurality of sheets to enter the sheet separation unit).

In a case where the conveyance sensor 27 does not detect a sheet even after a predetermined time elapses when a paper feed operation of feeding a sheet from the paper feed cassette 10 is normally started, the image forming apparatus 100 determines that a jam has occurred in the sheet (topmost sheet S1) and stops the printing operation. In the image forming apparatus 100, also in a case where a plurality of sheets have further entered the sheet separation unit (vicinity of the separation position 22A) (FIG. 6), sheet conveyance is hindered by the increase in the conveyance resistance described above (the conveyance sensor 27 does not detect the sheet even if a predetermined time elapses after the start of the paper feed operation), whereby a jam may occur.

As described above, regarding the jam occurring due to a plurality of sheets having entered the sheet separation unit (vicinity of the separation position 22A), the CPU 71 (the control unit 70) may perform processing of notifying (displaying) a candidate for the factor based on the determination result described above. In a case of having performed, a plurality of times, the determination that a plurality of sheets have entered the sheet separation unit, before the occurrence of the jam, the control unit 70 may notify, as a candidate for the factor of the jam, that the plurality of sheets have entered the sheet separation unit (vicinity of the separation position 22A). For example, the CPU 71 may display, on the operation unit 82, a message performs control such that "Since a plurality of sheets have entered the sheet separation unit, there is a possibility that a paper jam has occurred." ‎

The CPU 71 may notify a user determined as a user who tends to have a plurality of sheets enter the separation position 22A of a message for guiding handling of the sheets to be set into the image forming apparatus 100 in order to prevent the occurrence of a jam. For example, the CPU 71 may display the following message on the operation unit 82 regarding the method recommended when setting sheets.

"Please loosen the sheets to set them."

"Please rotate the sheets by 180 degrees or flip the sheets to set them."

"Please rotate the sheets by 90 degrees to set them, and feed them with the setting of lateral feed or shot edge feed."

"When placing new sheets into the paper feed cassette, please set the sheets without dividing them into small bundles."

"Please use up the sheets in the cassette before placing new sheets."

The CPU 71 may display the following message on the operation unit 82 in order to prevent a jam (paper jam) related to the characteristics of the sheet.

"Please check that there is no damage or burrs/bends at the edges on the sheets, and remove the sheets if any."

"Please avoid using paper in contact with wrapping paper."

"Please refrain from using recycled paper if using one."

"Please change the type of sheet."

In a case where the image forming apparatus 100 includes a plurality of paper feed units (paper feed cassettes or trays), the CPU 71 may display, on the operation unit 82, a message for guiding to set sheets in a manual feed tray in which sheets can be set one by one (e.g., "Please change the tray for storing sheets to a manual feed tray.") ‎

Note that the above-described notification processing is an example, and the CPU 71 operates so as to notify of a message regarding sheet handling for preventing a plurality of sheets from entering the vicinity of the separation position 22A as much as possible in the notification processing. Entry of a plurality of sheets into the vicinity of the separation position 22A at the paper feed start can result in paper dust adhering to the feed roller 21 or the separation roller 22, or a phenomenon in which the progress of abrasion of the separation roller 22 is accelerated due to the adhesion of paper dust, in addition to the occurrence of a jam (paper jam). Therefore, the above-described notification processing is also effective for preventing the occurrence of such a phenomenon.

Other than the notification processing using the operation unit 82 of the image forming apparatus 100, the CPU 71 may perform notification processing using the operation unit 92 of the host computer 90. For example, in S109, the CPU 71 may notify, via the network, the host computer 90 of a message indicating the notification content in the operation unit 92.

### Other Notification Examples

In the present embodiment, an example in which a plurality of sheets enter the vicinity of the separation position 22A in a case where the sheet bundle S2 is added onto the sheet bundle S3 remaining in the paper feed cassette 10 has been described. However, when the number of sheets in the paper feed cassette 10 decreases and the last plurality of sheets remain in the paper feed cassette 10, the plurality of sheets may enter the vicinity of the separation position 22A.

In order to prevent this, the paper feed cassette 10 can include, as a multi feed prevention member, a last sheet separation sheet (not illustrated) using a rubber material, a nonwoven fabric, or the like, but the friction coefficient of the separation sheet may decrease due to adhesion of paper dust or abrasion. As a result, when the number of sheets in the paper feed cassette 10 decreases and feed of the last sheet approaches, a plurality of sheets may enter the vicinity of the separation position 22A, and this may lead to occurrence of a jam (paper jam) or the like. Therefore, in a case of detecting that the number of sheets in the paper feed cassette 10 has decreased using the sensor or the like provided in the paper feed cassette 10, the CPU 71 (the control unit 70) may notify of a message prompting replacement or cleaning of the last sheet separation sheet (multi feed prevention member) in the paper feed cassette 10 in a case of determining that a plurality of sheets tend to enter the separation position 22A.

### Overview

As described above, the image forming apparatus 100 of the present embodiment includes the conveyance sensor 27 that is arranged downstream of the sheet separation unit (feed roller 21 and separation roller 22) in the sheet conveyance direction and that can detect the sheet. The control unit 70 (CPU 71) acquires a result of detection by the conveyance sensor 27 every time the paper feed operation by the pick roller 20 is performed, determines whether or not a plurality of sheets are present in the detection section TD based on the acquired detection result, and notifies of information based on the determination result. In this manner, in a case where the information based on the detection result of the detection unit indicates that a plurality of recording materials (sheets) are simultaneously positioned in the notification section (detection section TD), the control unit 70 (CPU 71) notifies of information regarding the presence of the plurality of recording materials in the notification section.

According to the present embodiment, it is possible to determine that the paper feed operation is performed in a state in which a plurality of sheets are present in the vicinity of the sheet separation unit in the image forming apparatus 100 and notify of information based on the determination result. This can appropriately identify the factor of a malfunction in a case where a malfunction occurs due to a plurality of sheets entering the vicinity of the sheet separation unit in the image forming apparatus. For example, it is possible to specify that the malfunction that occurred is due to how the user used (setting method of the sheet, or the like) or the characteristics of the sheet (determine that the malfunction is due to a failure of the apparatus). In this manner, according to the present embodiment, it is possible to provide an image forming apparatus that detects a state in which a recording material is not normally conveyed.

By such determination processing and notification processing, for example, an IT manager can appropriately handle a malfunction that occurred in the image forming apparatus 100. For example, a service provider who performs maintenance management of the image forming apparatus can appropriately determine the necessity of service dispatch, and it is possible to suppress unnecessary dispatch and to achieve more efficient solution of the malfunction.

According to the present embodiment, it is possible to grasp that a plurality of sheets tend to enter the (vicinity of) sheet separation unit when image formation is performed. This can appropriately notify the user of information for preventing a malfunction such as a jam in advance before the malfunction occurs.

### Modification using Server Apparatus

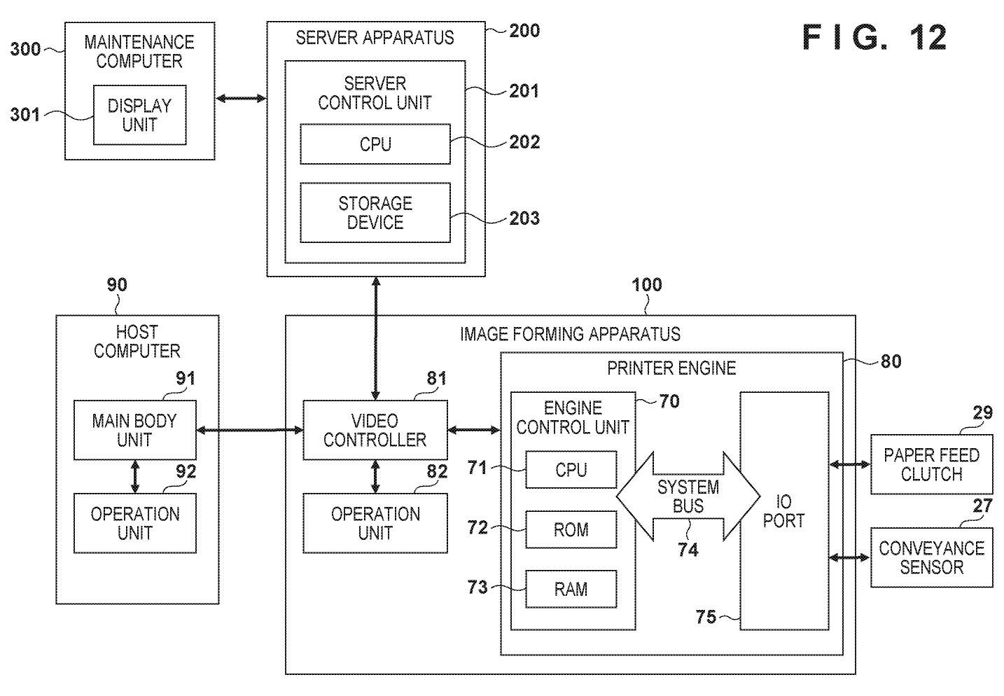

In the present embodiment, an example in which the image forming apparatus 100 performs the above-described determination processing and notification processing has been described, but the processing may be performed by an external apparatus. FIG. 12 illustrates a configuration example of an image forming system further including a server apparatus 200 that can communicate with the image forming apparatus 100 via a network and a maintenance computer 300 connected to the server apparatus 200. In the present embodiment, the server apparatus 200 is an example of an information processing apparatus that can communicate with the image forming apparatus, and the maintenance computer 300 is an example of a display apparatus that can display information.

In the image forming system of FIG. 12, the server apparatus 200 includes a control unit 201, and the control unit 201 includes a CPU 202 and a storage device 203. The maintenance computer 300 includes a display unit 301. The maintenance computer 300 can be, for example, a terminal apparatus of an IT manager in an office or a terminal apparatus of a service provider in charge of maintenance (a PC or the like on which a monitoring tool or the like is operable). The maintenance computer 300 is configured to be able to receive, as necessary, and display, on the display unit 301, information based on a determination result stored in the server apparatus 200.

In the image forming apparatus 100, the control unit 70 (CPU 71) acquires the measurement result of the sensor reach time Ts every time the sheet paper feed operation is performed according to the procedure of FIG. 11 described above (S103). The CPU 71 holds, into the RAM 73, the measurement value of the sensor reach time Ts for each fed sheet. Thereafter, the CPU 71 transmits the information held in the RAM 73 to the server apparatus 200 in response to the fact that the number of fed sheets (the number of sheets holding the measurement results of the sensor reach time Ts) has reached a prescribed number of sheets or a prescribed time has elapsed.

The server apparatus 200 stores, into the storage device 203, the information received from the image forming apparatus 100. The CPU 202 analyzes the information stored in the storage device 203. The CPU 202 executes the processing in and after S104 using the information stored in the storage device 203 in the processing procedure of FIG. 11, for example. By this, the server apparatus 200 performs the above-described determination processing to generate a determination result, and performs notification processing of the determination result (S107 to S109). The notification processing of the determination result may be performed using the display unit 301 of the maintenance computer 300 by transmitting the determination result or information based on the determination result to the maintenance computer 300, for example. As illustrated in FIG. 24, the maintenance computer 300 displays, on the display unit 301, a screen including information regarding presence of a plurality of recording materials in the notification section (detection section TD), thereby notifying of the information.

The notification content in the maintenance computer 300 may be the above-described content or may be content for the IT manager or the service provider in charge of maintenance as in the following message, for example.

"A plurality of sheets tend to enter the sheet separation unit. Since a jam is highly likely to occur, please give the user an instruction for an appropriate paper setting method."

"A jam is occurring due to a plurality of sheets entering the sheet separation unit. Please give the user an instruction for an appropriate paper setting method."

The above-described notification processing is an example, and the notification may have content of conveying processing for preventing the occurrence of the jam based on the determined (grasped) tendency of the user, or may have content for prompting the user to perform appropriate processing from the factor of the occurrence of the jam. With the execution frequency of the above-described determination processing in the server apparatus 200 being set to once a day, determination in which data of the day and previous data are combined may be performed, and the notification content may be determined based on the determined (grasped) tendency of the user.

In this manner, the image forming system includes the image forming apparatus 100, the information processing apparatus (server apparatus 200) that can communicate with the image forming apparatus 100, and the display apparatus (maintenance computer 300) that can display information. The image forming apparatus 100 includes the storage unit (paper feed cassette 10) that stores the recording material, the paper feed unit (pick roller 20), the separation unit (feed roller 21 and separation roller 22), and the detection unit (conveyance sensor 27) that detects the recording material being conveyed. The paper feed unit includes a paper feed contact portion that comes into contact with the recording material stored in the storage unit, and feeds the recording material in contact with the paper feed contact portion. The separation unit is provided downstream of the paper feed unit in the conveyance direction in which the paper feed unit conveys the recording material, includes a separation contact portion that comes into contact with the recording material fed by the paper feed unit, and separates the recording material into one to convey the recording material. In a case where the information based on the detection result of the detection unit indicates that a plurality of recording materials are simultaneously positioned in the notification section (detection section TD), the information processing apparatus (server apparatus 200) gives notification by causing the display apparatus (maintenance computer 300) to display information regarding that the plurality of recording materials are present in the notification section. The notification section is defined as a section downstream of the midpoint of a line segment connecting the paper feed contact portion and the separation contact portion and upstream of the separation contact portion in the conveyance direction of the recording material.

In this manner, according to the present embodiment, it is possible to provide an image forming system that detects a state in which a recording material is not normally conveyed and appropriately notifies of information regarding the detection result. Note that an example in which the configuration of the first embodiment is applied to an image forming system has been described here, but the configurations of the second to sixth embodiments described below can be similarly applied to the above-described image forming system.

### Second Embodiment

In the second embodiment, an example of determining that the paper feed operation is performed in a state in which a plurality of sheets are present in the vicinity of the sheet separation unit using a sheet sensor arranged upstream of the sheet separation unit (separation position 22A) in the sheet conveyance direction will be described. Hereinafter, description of parts common to the first embodiment will be omitted.

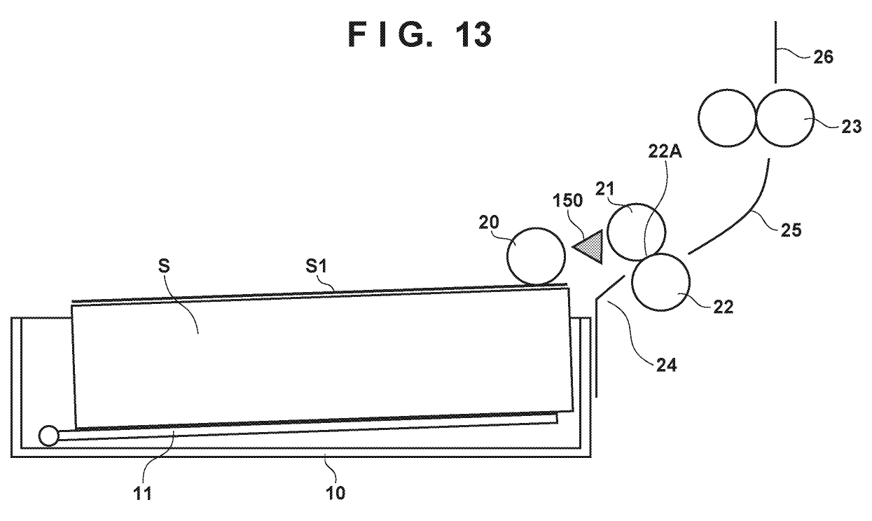

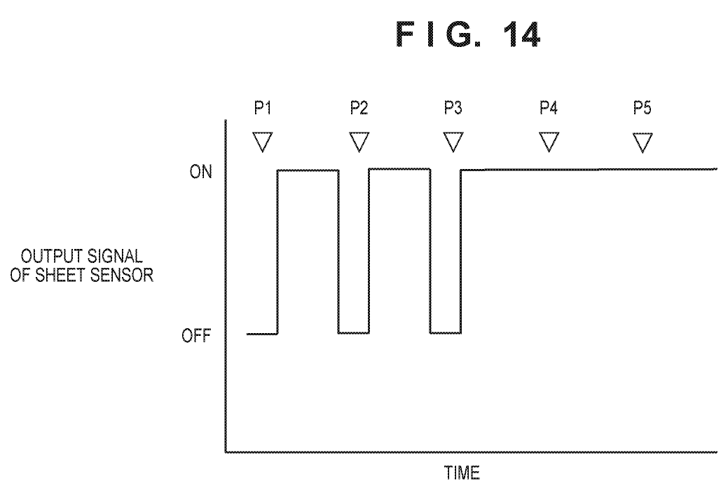

FIG. 13 is a cross-sectional view illustrating a configuration example related to paper feed of a sheet in the image forming apparatus 100 of the present embodiment. The image forming apparatus 100 of the present embodiment includes a sheet sensor 150 arranged upstream of the sheet separation unit in place of the conveyance sensor 27 (FIG. 2) arranged downstream of the sheet separation unit (feed roller 21 and separation roller 22) in the sheet conveyance direction. FIG. 14 illustrates an example of a state of an output signal of the sheet sensor 150, where the horizontal axis indicates time and the vertical axis indicates the state (on state or off state) of the output signal.

The sheet sensor 150 includes a photointerrupter and a flag (not illustrated), and is used to detect the sheet S1. In a case where the sheet S1 comes into contact with the flag and the optical axis of the photointerrupter is shielded from light, the sheet sensor 150 outputs a signal in the on state indicating that the sheet is detected. In a case where the sheet S 1does not come into contact with the flag and the optical axis of the photointerrupter is not shielded from light, the sheet sensor 150 outputs a signal in the off state indicating that the sheet is not detected.

The sheet sensor 150 is arranged at a position upstream of the sheet separation unit (separation position 22A) in the sheet conveyance direction, the position where presence or absence of the sheet in the vicinity of the separation position 22A can be detected. In this manner, the sheet sensor 150 is an example of a detection unit that detects

the recording material (sheet) being conveyed. In the present embodiment, the detection unit (sheet sensor 150) is arranged upstream of the sheet separation unit (feed roller 21 and separation roller 22) in the sheet conveyance direction. The control unit 70 (CPU 71) monitors an output signal of the sheet sensor 150 via the IO port 75 and the system bus 74. In a case where the output signal of the sheet sensor 150 is in the on state, the control unit 70 can determine that the topmost sheet S1 is present in the vicinity of the separation position 22A. In a case where the output signal is in the off state, the control unit 70 can determine that the topmost sheet S1 is not present in the vicinity of the separation position 22A.

More specifically, the sheet sensor 150 can be arranged within the detection section TD described in the first embodiment. For example, similarly to the first embodiment, a section from the midpoint position 28 to the separation position 22A in the sheet conveyance direction is set as the detection section TD. In this case, the control unit 70 can count the sheet detected by the sheet sensor 150 at the paper feed start timing of the sheet as a sheet whose paper feed start position is within the detection section TD (notification section). Note that similarly to the first embodiment, the control unit 70 includes a sheet counter for counting sheets in the detection section TD (sheets whose paper feed start position is in the detection section TD).

Next, processing for determining that a plurality of sheets are present in the vicinity of (have entered) the separation position 22A, which is to be executed by the control unit 70 (CPU 71), will be described using the example of FIG. 14. In the present embodiment, processing described below is performed as processing in S102 to S104 in the processing procedure shown in FIG. 11.

In the example of FIG. 14, P1 to P5 indicate timings (paper feed start timings) at which the CPU 71 transmits (outputs) a control signal for paper feed start to the paper feed clutch 29, and for example, P1 corresponds to the first sheet, and P5 corresponds to the fifth sheet. In a case where the topmost sheet S1 is present at the position illustrated in FIG. 13 (cassette position 10B in FIG. 7), the output signal of the sheet sensor 150 is in the off state at the paper feed start timing P1 as illustrated in FIG. 14. Thereafter, when the topmost sheet S1 is fed, the sheet sensor 150 outputs a signal in the on state from when the leading edge of the sheet S1 is detected until the trailing edge passes through the position of the sheet sensor 150. When the trailing edge of the sheet S1 passes the position of the sheet sensor 150, the output signal of the sheet sensor 150 is switched from the on state to the off state.

In the present embodiment, the CPU 71 determines whether or not the paper feed start position of the fed sheet is within the detection section TD based on the output signal of the sheet sensor 150 at the paper feed start timing (P1 to P5) of the sheet. In a case where the output signal of the sheet sensor 150 at each paper feed start timing is in the on state (sheet is detected), the CPU 71 determines that the paper feed start position of the fed sheet is within the detection section TD. In this case, the CPU 71 performs processing of incrementing the count value of the sheet counter by 1 (S105). On the other hand, in a case where the output signal of the sheet sensor 150 at each paper feed start timing is in the off state (no sheet is detected), the CPU 71 determines that the paper feed start position of the fed sheet is out of the detection section TD. In this case, the CPU 71 performs processing of decrementing the count value of the sheet counter by 1 (in a case where the count value is 0, it is kept at 0) (S106).

In the example of FIG. 14, the output signal of the sheet sensor 150 at each of the paper feed start timings P1 to P3 is in the off state. Therefore, the CPU 71 determines that the paper feed start position is out of the detection section TD for the fed first to third sheets, and decrements the count value of the sheet counter by 1 (S106).

Thereafter, it is assumed that a phenomenon occurs in which a plurality of sheets enter the vicinity of the separation position A from the paper feed cassette 10 when the third sheet is fed. In this case, even if the trailing edge of the third sheet (topmost sheet S1) passes the position of the sheet sensor 150, the next fourth sheet is brought into a state of already existing at the position of the sheet sensor 150. In this case, as illustrated in FIG. 14, the output signal of the sheet sensor 150 at the paper feed start timing P4 is brought into the on state. Therefore, the CPU 71 determines that the paper feed start position is within the detection section TD for the fed fourth sheet, and increments the count value of the sheet counter by 1 (S105).

In the present embodiment, furthermore, even if the trailing edge of the fourth sheet (topmost sheet S1) passes the position of the sheet sensor 150, the next fifth sheet is brought into a state of already existing at the position of the sheet sensor 150. In this case, as illustrated in FIG. 14, the output signal of the sheet sensor 150 at the paper feed start timing P5 is brought into the on state. Therefore, the CPU 71 determines that the paper feed start position is within the detection section TD for the fed fifth sheet, and further increments the count value of the sheet counter by 1 (S105).

Thereafter, similarly to the first embodiment, the CPU 71 determines whether or not a plurality of sheets are present in the vicinity of the separation position 22A (present in the detection section TD) based on the count value of the sheet counter, and performs processing of notifying of information based on the determination result (S107 to S109).

As described above, in the present embodiment, every time the paper feed operation is performed by the pick roller 20, the control unit 70 (CPU 71) counts the sheets whose paper feed start position is within the detection section TD based on the result of detection by the sheet sensor 150, and determines whether or not a plurality of sheets are present in the detection section TD based on the obtained count value. According to the present embodiment, a simple configuration similarly to the first embodiment makes it possible to determine whether or not a plurality of sheets have entered the vicinity of the separation position 22A (paper feed operation is performed in a state in which the plurality of sheets are present in the vicinity of the sheet separation unit) and notify of information based on the determination result.

### Third Embodiment

As the third embodiment, a modification of the second embodiment will be described. Hereinafter, description of parts common to the first and second embodiments will be omitted.

The image forming apparatus 100 of the present embodiment has a configuration illustrated in FIG. 13 as a configuration related to paper feed of a sheet, similarly to the second embodiment. However, in the present embodiment, a thickness sensor that can detect the thickness of the sheet is used as the sheet sensor 150. The sheet sensor 150 is configured to detect the thickness of the sheet using ultrasound. Similarly to the second embodiment, the sheet sensor 150 is configured to be arranged within the detection section TD (within a predetermined section), and to output, as detection information, information indicating the thickness of the sheet present at the detection position within the detection section TD. Note that in a case where no sheet is present at the detection position in the detection section TD, the sheet sensor 150 outputs detection information indicating that the thickness is 0. Based on the detection information output from the sheet sensor 150, it is possible to determine the thickness of the sheet at the detection position and it is also possible to determine how many sheets are present at the detection position.

The control unit 70 (CPU 71) monitors an output signal of the sheet sensor 150 via the IO port 75 and the system bus 74. The control unit 70 determines whether or not a plurality of sheets are present in the detection section TD based on the detection information included in the output signal from the sheet sensor 150 at the paper feed start timing of the sheet. For example, the control unit 70 may compare the thickness of the sheet indicated by the detection information with a determination threshold, and determine that a plurality of sheets are present in the detection section TD in a case where the thickness is the threshold or more.

In this manner, in the present embodiment, the determination result as to whether or not a plurality of sheets are present in the detection section TD can be acquired based on the detection information of the sheet sensor 150 without using the count value of the sheet counter described in the first and second embodiments. The control unit 70 (CPU 71) performs processing of notifying of information based on the determination result, similarly to the first and second embodiments.

According to the present embodiment, similarly to the first and second embodiments, it is possible to determine that the paper feed operation is performed in a state in which a plurality of sheets are present in the vicinity of the sheet separation unit in the image forming apparatus 100 and notify of information based on the determination result. This can appropriately identify the factor of a malfunction in a case where a malfunction occurs due to a plurality of sheets entering the vicinity of the sheet separation unit in the image forming apparatus.

Note that in the present embodiment, the above-described determination is performed using the detection information of the sheet sensor 150 at the paper feed start timing, but the present invention is not limited to this, and a similar determination may be performed using the detection information of the sheet sensor 150 at the time of an occurrence of a jam, for example. This makes it also possible to promptly notify the user or the manager, as the factor of the jam, that a plurality of sheets have entered the separation unit.

### Fourth Embodiment

In the fourth embodiment, an example will be described in which a rotation detection unit including an encoder is arranged in the detection section TD, and whether or not a plurality of sheets have entered the vicinity of the separation position 22A is determined based on the result of detection by the rotation detection unit. Hereinafter, description of parts common to the first embodiment will be omitted. Hereinafter, description of parts common to the first embodiment will be omitted.

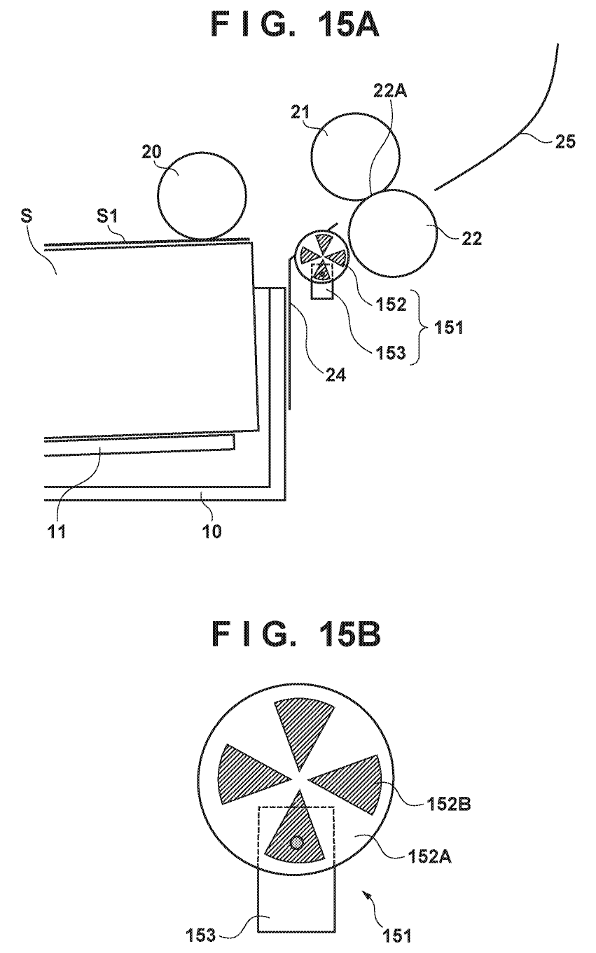

FIG. 15A is a cross-sectional view illustrating a configuration example related to paper feed of a sheet in the image forming apparatus 100 of the present embodiment. The image forming apparatus 100 of the present embodiment includes a rotation detection unit 151 arranged upstream of the separation unit in place of the conveyance sensor 27 (FIG. 2) arranged downstream of the separation unit including the feed roller 21 and the separation roller 22 in the sheet conveyance direction. FIG. 15B is a schematic view illustrating a configuration example of rotation detection unit 151. The rotation detection unit 151 includes an encoder 152 and a photointerrupter 153.

The encoder 152 has a closed portion 152A and a slit portion (opening portion) 152B. In a case where the position of the closed portion 152A of the encoder 152 is aligned with the optical axis of the photointerrupter 153 according to the rotation of the encoder 152, the photointerrupter 153 outputs a signal indicating a light shielding state. In a case where the slit portion 152B of the encoder 152 is aligned with the optical axis of the photointerrupter 153, the photointerrupter 153 outputs a signal indicating a light transmitting state.

The rotation detection unit 151 is arranged at a position upstream of the separation unit (separation position 22A) in the sheet conveyance direction, the position where the sheet in the vicinity of the separation position 22A can be detected. More specifically, the rotation detection unit 151 can be arranged within the detection section TD described in the first embodiment. For example, similarly to the first embodiment, a section from the midpoint position 28 to the separation position 22A in the sheet conveyance direction is set as the detection section TD. In the present embodiment, the rotation detection unit 151 is an example of a detection unit that is arranged within the notification section (within the detection section TD), includes the encoder 152 that is configured to come into contact with the lower surface of the recording material (sheet) and rotate in accordance with conveyance of the recording material in contact, and outputs a signal indicating presence or absence of rotation of the encoder.

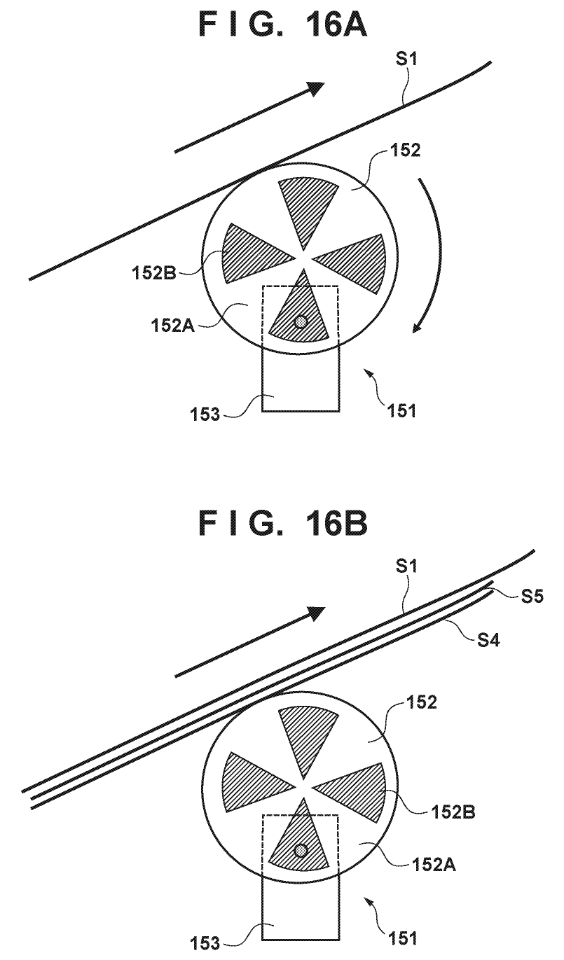

FIGS. 16A and 16B illustrate operation examples of the encoder 152 at the time of reach of a sheet. FIG. 16A illustrates a state in which only one sheet (topmost sheet S1) is fed by the sheet paper feed operation and reaches the position of the encoder 152 in the detection section TD. In this case, the encoder 152 rotates with the movement of the sheet. By this, the closed portion 152A and the slit portion 152B are alternately aligned with the optical axis of the photointerrupter 153 according to the rotation of the encoder 152, whereby the photointerrupter 153 outputs a signal for alternately switching the light transmitting state and the light shielding state.

On the other hand, FIG. 16B illustrates a state in which a plurality of sheets (topmost sheet S1 and other sheets S4 and S5) reach the position of the encoder 152 in the detection section TD. The sheet S4 is a sheet in contact with the encoder 152. The sheet S5 is a sheet present immediately above the sheet S4. In this case, since the separation roller 22 (FIG. 15A) is stopped, conveyance of the sheets S4 and S5 is stopped, and only the topmost sheet S1 is conveyed by the feed roller 21 (FIG. 15A). The rotational torque of the torque limiter incorporated in the separation roller 22 is set such that the separation roller 22 rotates when sheets are conveyed one by one, and the separation roller 22 does not rotate when a plurality of sheets are conveyed as described above.

In this manner, since the conveyance (movement) of the sheet S4 in contact with the encoder 152 is stopped, the encoder 152 is stopped without rotating. By this, the photointerrupter 153 does not output the signal for alternately switching the light transmitting state and the light shielding state, and outputs a constant signal indicating the light transmitting state or the light shielding state.

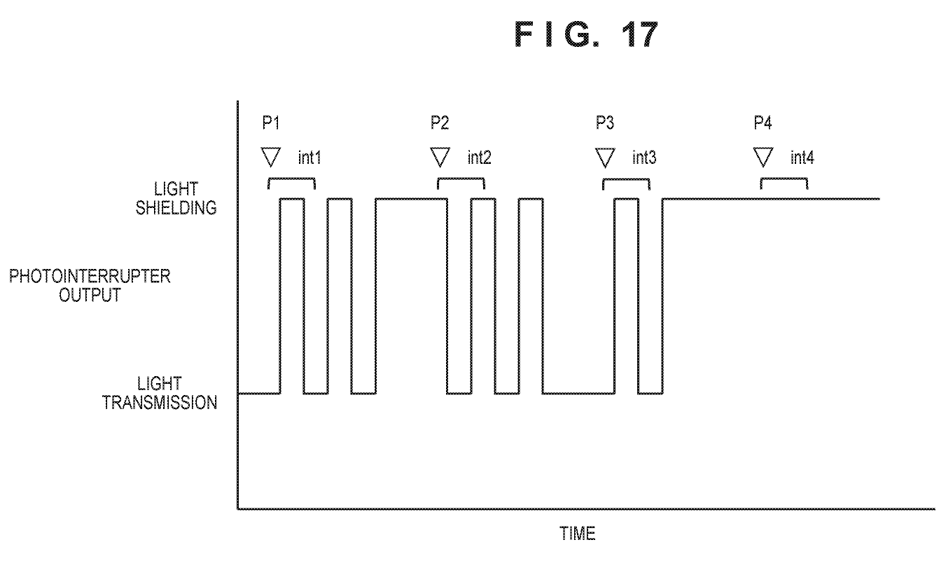

FIG. 17 illustrates an example of a state indicated by the output signal of the rotation detection unit 151 (photointerrupter 153), where the horizontal axis indicates time and the vertical axis indicates a state (light shielding state or light transmitting state) indicated by the output signal. Hereinafter, an operation example of the rotation detection unit 151 when the sheet paper feed operation is actually performed will be described with reference to FIG. 17.

In FIG. 17, the paper feed start timings P1 to P4 indicate timings at which the CPU 71 transmits (outputs) a control signal for paper feed start to the paper feed clutch 29, similarly to FIG. 14. Periods int1 to int4 are predetermined periods with the respective paper feeding timings P1 to P4 as start points, and are set as rotation detecting periods for detecting presence or absence of rotation of the encoder 152. As an example, each rotation detecting period is set as a time from each paper feed start timing until a region of 1/3 of the length in the conveyance direction of the topmost sheet S1 passes through the position of the encoder 152.

In the present embodiment, the control unit 70 (CPU 71) determines whether or not the encoder 152 is rotating based on an output signal of the rotation detection unit 151 (photointerrupter 153) in each rotation detecting period. That is, the CPU 71 determines whether or not a plurality of sheets have entered the detection section TD based on the output signal of the rotation detection unit 151 in each rotation detecting period.

In the example of FIG. 17, paper feed of the first to third sheets is started as the topmost sheet S1 at the position (cassette position 10B in FIG. 7) illustrated in FIG. 15A. First, when the feed of the topmost sheet S1 is started at the paper feed start timing P1 and (the leading edge of) the topmost sheet S1 reaches the rotation detection unit 151, the encoder 152 starts to rotate. Thereafter, while the topmost sheet S1 is conveyed in the detection section TD, the rotation detection unit 151 (photointerrupter 153) outputs a signal for alternately switching the light transmitting state and the light shielding state according to the rotation of the encoder 152 with which the sheet S1 comes in contact. In this manner, the rotation detection unit 151 outputs a signal indicating that the encoder 152 is rotating. For example, in a case where the output signal of the rotation detection unit 151 in the rotation detecting period int1 repeats the light transmitting state and the light shielding state a predetermined number of times, the CPU 71 determines that the paper feed start position is out of the detection section TD for the first sheet. Furthermore, the CPU 71 decrements the count value of the sheet counter described above by 1 (S106 in FIG. 11). In the example of FIG. 17, the same applies to the second sheet and the third sheet.

Thereafter, it is assumed that a phenomenon occurs in which a plurality of sheets enter the vicinity of the separation position A from the paper feed cassette 10 when the third sheet is fed. In this case, after the conveyance of the third sheet (topmost sheet S1), at the paper feed start timing P4, a plurality of sheets including the next fourth sheet (topmost sheet S1) are present in (have entered) the detection section TD, and the leading edge of the topmost sheet S1 is in a state of reaching the separation position 22A. In this case, as described above, even if the topmost sheet S1 is conveyed by the feed roller 21, conveyance of other sheets is stopped, and therefore the encoder 152 does not rotate in the rotation detection section int4. Therefore, the rotation detection unit 151 (photointerrupter 153) outputs a constant signal indicating the light transmitting state or the light shielding state. In this manner, the rotation detection unit 151 outputs a signal indicating that the encoder 152 is not rotating. For example, in a case where the output signal of the rotation detection unit 151 in the rotation detecting period int4 is constant, the CPU 71 determines that the paper feed start position is within the detection section TD for the fourth sheet. Furthermore, the CPU 71 increments the count value of the sheet counter described above by 1 (S105 in FIG. 11).

Thereafter, similarly to the first embodiment, the CPU 71 determines whether or not a plurality of sheets are present in the vicinity of the separation position 22A (present in the detection section TD) based on the count value of the sheet counter, and performs processing of notifying of information based on the determination result (S107 to S109 in FIG. 11).

In this manner, according to the present embodiment, a simple configuration using the encoder makes it possible to determine whether or not a plurality of sheets have entered the vicinity of the separation position 22A (paper feed operation is performed in a state in which the plurality of sheets are present in the vicinity of the sheet separation unit). Information based on the determination result can be notified. This can appropriately identify the factor of a malfunction in a case where a malfunction occurs due to a plurality of sheets entering the vicinity of the sheet separation unit in the image forming apparatus 100, similarly to the first embodiment.

### Fifth Embodiment

In the fifth embodiment, an example will be described in which a rotation detection unit that detects rotation of the separation roller 22 is provided with respect to the separation roller 22, and whether or not a plurality of sheets have entered the vicinity of the separation position 22A is determined based on the result of detection by the rotation detection unit. Hereinafter, description of parts common to the first embodiment will be omitted.

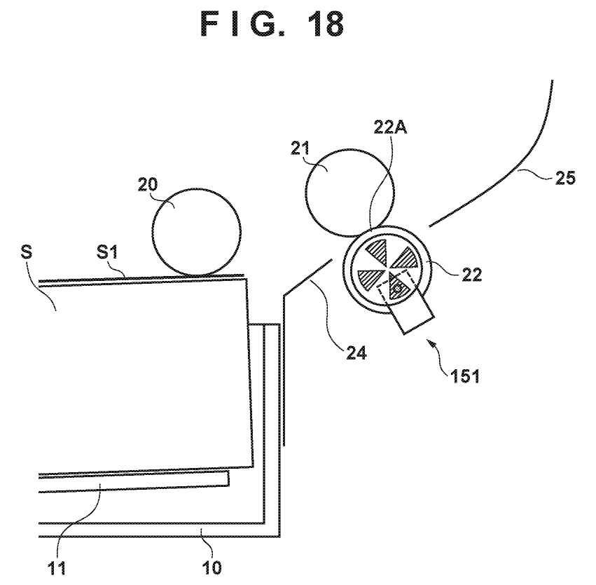

FIG. 18 is a cross-sectional view illustrating a configuration example related to paper feed of a sheet in the image forming apparatus 100 of the present embodiment. As illustrated in FIG. 18, the rotation detection unit 151 is configured to be provided in the separation roller 22, and detect the sheet by (presence or absence of) rotation of the separation roller 22. The rotation detection unit 151 has a similar configuration to the rotation detection unit 151 of the fourth embodiment, that is, has a configuration including the encoder 152 and the photointerrupter 153. As described in the first embodiment, the separation roller 22 incorporates a torque limiter. The rotational torque of the torque limiter is set in advance such that the separation roller 22 rotates when sheets are conveyed one by one, and the separation roller 22 does not rotate when a plurality of sheets are conveyed.

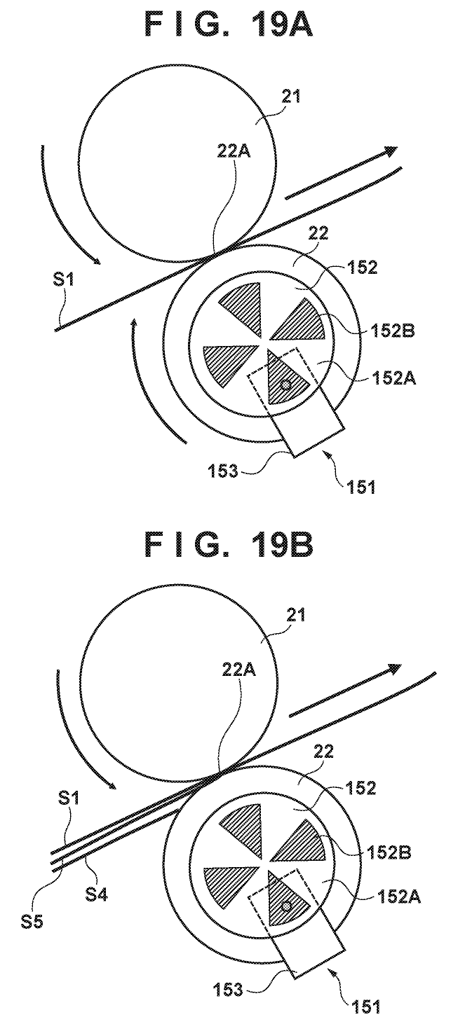

FIGS. 19A and 19B illustrate operation examples of the rotation detection unit 151 at the time of reach of a sheet to the separation position 22A. Note that in the image forming apparatus 100 of the present embodiment, a change in the output signal of the rotation detection unit 151 (photointerrupter 153) accompanying the paper feed and conveyance operation of the sheet is similar to that in FIG. 17 of the third embodiment.

FIG. 19A illustrates a case where one sheet (topmost sheet S1) is fed by the sheet paper feed operation, and the sheet enters the separation position 22A. This corresponds to a case where the first to third sheets in the example of FIG. 17 enter the separation position 22A. FIG. 19B illustrates a case where the topmost sheet S1 enters the separation position 22A, and a plurality of other sheets (sheets S4 and S5) have entered (inside the detection section TD) the vicinity of the separation position 22A. This corresponds to a case where the fourth sheet in the example of FIG. 17 enters the separation position 22A.

In the example of FIG. 17, when feed of one sheet (topmost sheet S1) is started at the paper feed start timing P1 and the sheet reaches the separation position 22A, the separation roller 22 rotates while the sheet is conveyed by the feed roller 21, as illustrated in FIG. 19A. Meanwhile, the rotation detection unit 151 (photointerrupter 153) outputs a signal for alternately switching the light transmitting state and the light shielding state. For example, in a case where the output signal of the rotation detection unit 151 in the rotation detecting period int1 repeats the light transmitting state and the light shielding state a predetermined number of times, the CPU 71 determines that the paper feed start position is out of the detection section TD for the first sheet. Furthermore, the CPU 71 decrements the count value of the sheet counter described above by 1 (S106 in FIG. 11). In the example of FIG. 17, the same applies to the second sheet and the third sheet.

Thereafter, it is assumed that a phenomenon occurs in which a plurality of sheets enter the vicinity of the separation position A from the paper feed cassette 10 when the third sheet is fed. In this case, in a state in which the leading edge of the next fourth sheet (topmost sheet S1) reaches the separation position 22A, paper feed of the sheet is started at the paper feed start timing P4. At this time, as described above, while the topmost sheet S1 is conveyed by the feed roller 21, the rotation of the separation roller 22 is stopped, whereby the conveyance of other sheets is stopped. In this manner, since the rotation of the separation roller 22 is stopped, the rotation detection unit 151 (photointerrupter 153) outputs a constant signal indicating the light transmitting state or the light shielding state. For example, in a case where the output signal of the rotation detection unit 151 in the rotation detecting period int4 is constant, the CPU 71 determines that the paper feed start position is within the detection section TD for the fourth sheet. Furthermore, the CPU 71 increments the count value of the sheet counter described above by 1 (S105 in FIG. 11).

Thereafter, similarly to the first embodiment, the CPU 71 determines whether or not a plurality of sheets are present in the vicinity of the separation position 22A (present in the detection section TD) based on the count value of the sheet counter, and performs processing of notifying of information based on the determination result (S107 to S109 in FIG. 11).

In this manner, according to the present embodiment, similarly to the fourth embodiment, a simple configuration using the encoder makes it possible to determine that a plurality of sheets have entered the vicinity of the separation position 22A.

### Sixth Embodiment

In the sixth embodiment, an example will be described in which the torque of a drive motor that rotationally drives the pick roller 20 and the feed roller 21 (separation unit) is measured, and whether or not a plurality of sheets have entered the vicinity of the separation position 22A is determined based on the measurement result. Hereinafter, description of parts common to the first embodiment will be omitted.

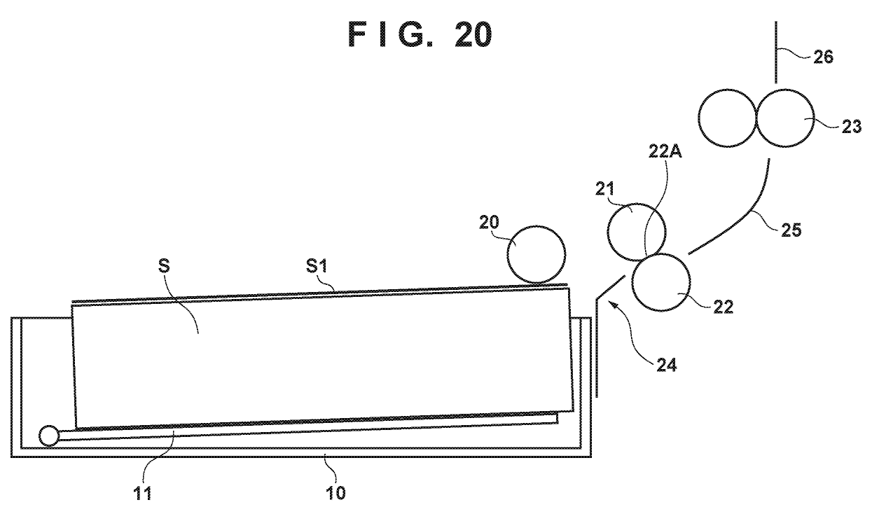

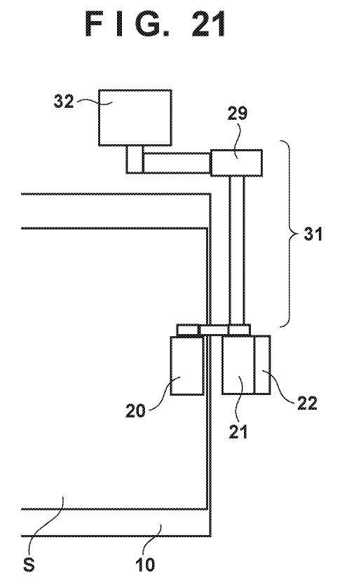

FIGS. 20 and 21 are a cross-sectional view and a top view, respectively, illustrating a configuration example related to paper feed of a sheet in the image forming apparatus 100 of the present embodiment. As illustrated in FIG. 20, the image forming apparatus 100 of the present embodiment does not include the conveyance sensor 27 of the first embodiment nor the rotation detection unit 151 of the fourth and fifth embodiments. A drive motor 32 illustrated in FIG. 21 rotationally drives the pick roller 20 and the feed roller 21 via a drive train 31 including the paper feed clutch 29. The drive motor 32 includes a torque sensor (not illustrated) that can measure torque on a motor shaft of the drive motor 32. The control unit 70 (CPU 71) can acquire, via the IO port 75 and the system bus 74, a measurement result by the torque sensor. In the present embodiment, the torque sensor is an example of a detection unit configured to detect the recording material (sheet) by detection of the torque for rotating the drive motor that rotationally drives the separation unit.

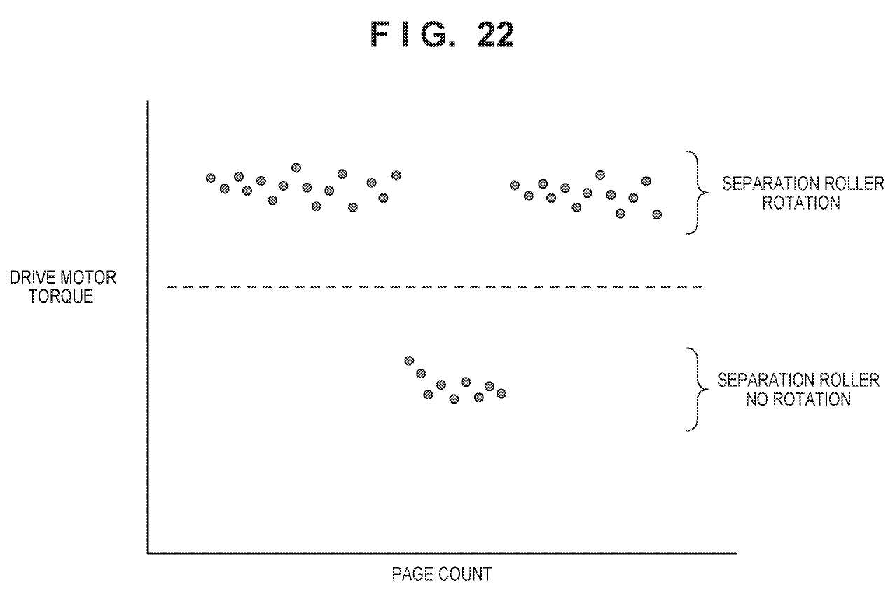

FIG. 22 is a view illustrating an example of a temporal change in the torque of the drive motor 32, where the horizontal axis indicates a page count and the vertical axis indicates a measurement value of the torque of the drive motor 32. FIG. 22 illustrates, for each page count, the maximum value of the torque measured in the rotation detecting period int1 with the paper feed start timing P1 illustrated in FIG. 17 as a start point.

As in FIG. 19A, in a case where one sheet enters the separation position 22A, the feed roller 21 rotates the separation roller 22. For this reason, torque larger than the torque of the torque limiter incorporated in the separation roller 22 is necessary as the torque of the drive motor 32. In this case, as illustrated in FIG. 22, the torque of the drive motor 32 has a relatively large value.

As in FIG. 19B, in the case where the topmost sheet S1 enters the separation position 22A, and a plurality of other sheets (sheets S4 and S5) have entered (inside the detection section TD) the vicinity of the separation position 22A, the feed roller 21 does not rotate the separation roller 22. For this reason, torque larger than the torque of the torque limiter incorporated in the separation roller 22 is unnecessary as the torque of the drive motor 32. In this case, as illustrated in FIG. 22, the torque of the drive motor 32 has a relatively small value.

In the present embodiment, the control unit 70 (CPU 71) acquires the measurement result by the torque sensor of the drive motor 32 every time the sheet paper feed operation is performed, and determines whether or not the paper feed start position of the fed sheet is within the detection section TD based on the acquired measurement result. For example, the determination is made based on a comparison result between the measured torque and a predetermined threshold. This threshold can be set in advance as a value between a measurement value of the torque of the drive motor 32 in a case of rotating the separation roller 22 and a measurement value of the torque of the drive motor 32 in a case of not rotating the separation roller 22.

Specifically, in a case where the measured torque is less than the threshold, the CPU 71 determines that the paper feed start position of the fed sheet is within the detection section TD. In this case, the CPU 71 performs processing of incrementing the count value of the sheet counter described above by 1 (S105 in FIG. 11). On the other hand, in a case where the measured torque is the threshold or more, the CPU 71 determines that the paper feed start position of the fed sheet is out of the detection section TD. In this case, the CPU 71 performs processing of decrementing the count value of the sheet counter by 1 (in a case where the count value is 0, it is kept at 0) (S106 in FIG. 11).

Thereafter, similarly to the first embodiment, the CPU 71 determines whether or not a plurality of sheets are present in the vicinity of the separation position 22A (present in the detection section TD) based on the count value of the sheet counter, and performs processing of notifying of information based on the determination result (S107 to S109 in FIG. 11).

In this manner, in the present embodiment, the configuration that can measure the torque of the drive motor 32 makes it possible to determine that the paper feed operation is being performed in a state in which a plurality of sheets are present in the vicinity of the sheet separation unit without using the conveyance sensor 27, and to notify of information based on the determination result.

### Other Embodiments

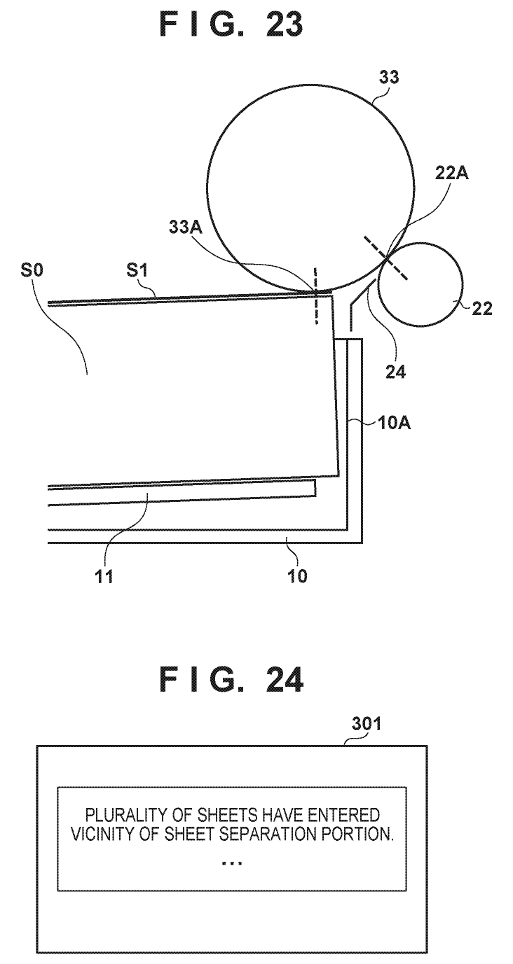

Each of the above-described embodiments can be variously modified. FIG. 23 is a cross-sectional view illustrating a configuration example related to paper feed of a sheet in the image forming apparatus 100 of a modification. In the present embodiment, the pick roller 20 and the feed roller 21 in the first to fifth embodiments are provided as one roller (pick feed roller 33). The pick feed roller 33 is configured to come into contact with the topmost sheet S1 of the sheet bundle S0 stored in the paper feed cassette 10 and also come into contact with the separation roller 22. A pick roller position 33A illustrated in FIG. 23 is a position where the pick feed roller 33 comes into contact with the topmost sheet S1. The separation position 22A corresponds to a contact portion where the pick feed roller 33 and the separation roller 22 come into contact with each other, and is a position where separation of the topmost sheet S1 from the other sheets is performed.

In the configuration example of FIG. 23, similarly to each of the above-described embodiments, the detection section TD is set to a section upstream of the sheet separation unit (separation position 22A) in the sheet conveyance direction, the section having the separation position 22A as the end point in the sheet conveyance direction. As an example, similarly to each of the above-described embodiments, a section from the position of the midpoint of a line segment connecting the pick roller position 33A and the separation position 22A to the separation position 22A is set as the detection section TD. Setting the detection section TD in this manner makes it possible to achieve determination processing and notification processing similar to those of each of the above-described embodiments also in a configuration using the pick feed roller 33, and to obtain similar effects.

In each of the embodiments described above, the image forming apparatus 100 configured as an electrophotographic laser beam printer is exemplified, but each of the embodiments can also be applied to an image forming apparatus such as a printer or a copier adopting another printing method (e.g., inkjet method).

According to the present disclosure, it is possible to provide an image forming apparatus (image forming system) that detects a state in which a recording material is not normally conveyed.

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-193958, filed November 5, 2024, which is hereby incorporated by reference herein in its entirety.

What is claimed is:

1. An image forming system comprising: an image forming apparatus; an information processing apparatus that can communicate with the image forming apparatus; and a display apparatus that can display information, wherein
the image forming apparatus includes
a storage unit that store a recording material,
a paper feed unit that includes a paper feed contact portion which comes into contact with the recording material stored in the storage unit, and that feeds the recording material which is in contact with the paper feed contact portion,
a separation unit that is provided downstream of the paper feed unit in a conveyance direction in which the paper feed unit conveys the recording material, and that includes a separation contact portion which comes into contact with the recording material fed by the paper feed unit, the separation unit separating the recording material into one to convey the recording material, and
a detection unit that detects the recording material being conveyed,
in a case where information based on a detection result of the detection unit indicates that a plurality of recording materials are simultaneously positioned in a notification section, the information processing apparatus gives notification such that the display apparatus displays information regarding that the plurality of recording materials are present in the notification section, and
the notification section is a section which is downstream of a midpoint of a line segment connecting the paper feed contact portion and the separation contact portion, and which is upstream of the separation contact portion, in the conveyance direction.

2. The image forming system according to claim 1, wherein
the detection unit is arranged downstream of the separation unit in the conveyance direction,
the image forming apparatus further includes a measurement unit that measures a time from a paper feed start timing of a recording material to a detection timing of the recording material by the detection unit, and
in a case where a measurement result of the measurement unit indicates that a plurality of recording materials are simultaneously positioned in a notification section, the information processing apparatus gives notification by causing the display apparatus to display information regarding that the plurality of recording materials are present in the notification section.

3. The image forming system according to claim 2, wherein
the information processing apparatus counts a recording material whose paper feed start position is within the notification section based on the measurement result of the measurement unit, and determines whether or not the plurality of recording materials are present in the notification section based on an obtained count value.

4. The image forming system according to claim 3, wherein
the information processing apparatus determines that the plurality of recording materials are present in the notification section in a case where the count value is a threshold or more.

5. The image forming system according to claim 1, wherein
the detection unit is arranged upstream of the separation unit in the conveyance direction, and
the information processing apparatus counts a recording material whose paper feed start position is within the notification section based on the detection result of the detection unit, and determines whether or not the plurality of recording materials are present in the notification section based on an obtained count value.

6. The image forming system according to claim 5, wherein
the detection unit is arranged within the notification section, and
the information processing apparatus counts, as a recording material whose paper feed start position is within the notification section, a recording material detected by the detection unit at a paper feed start timing of a recording material.

7. The image forming system according to claim 1, wherein
the detection unit is a sensor that is arranged within the notification section and can detect a thickness of a recording material, and
the information processing apparatus determines whether or not the plurality of recording materials are present in the notification section based on detection information of the sensor at a paper feed start timing of a recording material.

8. The image forming system according to claim 1, wherein
the detection unit includes an encoder configured to be arranged within the notification section, be in contact with a lower surface of a recording material, and rotate in accordance with conveyance of a recording material that is in contact, and the detection unit outputs a signal indicating presence or absence of rotation of the encoder, and
the information processing apparatus counts a recording material whose paper feed start position is within the notification section based on an output signal of the detection unit in a predetermined detecting period, and determines whether or not the plurality of recording materials are present in the notification section based on an obtained count value.

9. The image forming system according to claim 8, wherein
the separation unit includes a separation roller configured to rotate in a case where one recording material reaches and stop rotation in a case where a plurality of recording materials reach, and
the information processing apparatus
increments the count value by one in a case where the output signal in the predetermined detecting period indicates that the encoder is not rotating, and
decrements the count value by one in a case where the output signal in the predetermined detecting period indicates that the encoder is rotating.

10. The image forming system according to claim 1, wherein
the separation unit includes a separation roller configured to rotate in a case where one recording material reaches and stop rotation in a case where a plurality of recording materials reach, and the detection unit, and
the detection unit is configured to detect a recording material depending on presence or absence of rotation of the separation roller.

11. The image forming system according to claim 10, wherein
the detection unit outputs a signal indicating presence or absence of rotation of the separation roller, and
the information processing apparatus counts a recording material whose paper feed start position is within the notification section based on an output signal of the detection unit in a predetermined detecting period, and determines whether or not the plurality of recording materials are present in the notification section based on an obtained count value.

12. The image forming system according to claim 11, wherein
the information processing apparatus
increments the count value by one in a case where the output signal in the predetermined detecting period indicates that the separation roller is not rotating, and
decrements the count value by one in a case where the output signal in the predetermined detecting period indicates that the separation roller is rotating.

13. The image forming system according to claim 1, wherein
the separation unit includes a separation roller configured to rotate in a case where one recording material reaches and stop rotation in a case where a plurality of recording materials reach, and
the detection unit is configured to detect a recording material by detection of torque for rotating a drive motor that rotationally drives the separation unit.

14. The image forming system according to claim 13, wherein
the information processing apparatus counts a recording material whose paper feed start position is within the notification section based on the torque detected by the detection unit, and determines whether or not the plurality of recording materials are present in the notification section based on an obtained count value.

15. The image forming system according to claim 1, wherein
in a case where the information based on the detection result of the detection unit indicates that the plurality of recording materials are simultaneously positioned in the notification section, when a jam in which a recording material is not conveyed downstream from the separation unit in the conveyance direction occurs, the information processing apparatus notifies, as a factor of the jam, that the plurality of recording materials are present in the notification section.

16. The image forming system according to claim 1, wherein
the information processing apparatus notifies of information for handling the recording material to be stored in the storage unit.

17. The image forming system according to claim 16, wherein
the information processing apparatus notifies of a message prompting replacement or cleaning of a multi feed prevention member provided in the storage unit.

18. The image forming system according to claim 1, wherein
when a number of times of determining that the plurality of recording materials are present in the notification section reaches a predetermined number of times, the information processing apparatus notifies of a tendency for the plurality of recording materials to be present in the notification section at a paper feed start timing of a recording material.

19. An information processing apparatus that can communicate with an image forming apparatus, the image forming apparatus including a storage unit that stores a recording material, a paper feed unit that includes a paper feed contact portion which comes into contact with the recording material stored in the storage unit, and that feeds the recording material which is in contact with the paper feed contact portion, a separation unit that is provided downstream of the paper feed unit in a conveyance direction in which the paper feed unit conveys the recording material, and that includes a separation contact portion which comes into contact with the recording material fed by the paper feed unit, the separation unit separating the recording material into one to convey the recording material, and a detection unit that detects the recording material being conveyed, the information processing apparatus comprising:
a control unit that gives notification by causing a display apparatus to display information regarding that a plurality of recording materials are present in a notification section in a case where information based on a detection result of the detection unit received from the image forming apparatus indicates that the plurality of recording materials are simultaneously positioned in the notification section, wherein
the notification section is a section which is downstream of a midpoint of a line segment connecting the paper feed contact portion and the separation contact portion, and which is upstream of the separation contact portion, in the conveyance direction.

20. The information processing apparatus according to claim 19, wherein
the detection unit is arranged downstream of the separation unit in the conveyance direction,
the image forming apparatus further includes a measurement unit that measures a time from a paper feed start timing of a recording material to a detection timing of the recording material by the detection unit, and
in a case where a measurement result of the measurement unit indicates that a plurality of the recording materials are simultaneously positioned in a notification section, the control unit gives notification by causing the display apparatus to display information regarding that the plurality of recording materials are present in the notification section.
